(19) United States
(12) Patent Application Publication
(10) Pub. No.: US 2018/0005481 A1
(43) Pub. Date: Jan. 4, 2018

(54) SHEET PROCESSING SYSTEM

(71) Applicant: Kabushiki Kaisha Toshiba, Tokyo (JP)

(72) Inventor: Ayaka Nakanishi, Yokohama Kanagawa (JP)

(21) Appl. No.: 15/703,518

(22) Filed: Sep. 13, 2017

Related U.S. Application Data
(63) Continuation of application No. PCT/JP2015/004489, filed on Sep. 4, 2015.

(30) Foreign Application Priority Data
Mar. 13, 2015 (JP) 2015-050602

(51) Int. Cl. G07D 11/00; B65H 3/04; B65H 5/02; B65H 31/24

(52) U.S. Cl. CPC G07D 11/0084; G07D 11/0021; B65H 31/24; B65H 3/042; B65H 5/023; B65H 2701/1912

(57) ABSTRACT

To provide a sheet processing system which can properly perform sorting processing of a plurality of kinds of sheets, while making each of a plurality of sheet processing apparatuses effectively operate.

A sheet processing system of an embodiment has a plurality of sheet processing apparatuses, a sorting apparatus, a storage unit, an information acquisition unit, and a controller. The plurality of sheet processing apparatuses each has a plurality of stackers for stacking sheets. The plurality of sheet processing apparatuses each sorts and stacks the sheets in the plurality of stackers. The plurality of sheet processing apparatuses each outputs information of a stacking status of the sheets in each of the plurality of stackers. The sorting apparatus sorts and feeds a sheet group formed of a plurality of the sheets to any of the plurality of sheet processing apparatuses. The storage unit stores the information of the stacking status of the sheets in each of the plurality of sheet processing apparatuses. The controller controls sorting of the sheet group by the sorting apparatus, based on the information of the sheet group which the information acquisition unit acquires, and the information of the stacking status of the sheets in the storage unit.

### CROSS-REFERENCE TO RELATED APPLICATIONS

This application is a by-pass continuation application of International Application No. PCT/JP2015/004489, filed Sep. 4, 2015, incorporated herein by reference, and which is based upon and claims the benefit of priority from Japanese Patent Application No. 2015-050602, filed Mar. 13, 2015, the entire contents of which are incorporated herein by reference.

### TECHNICAL FIELD

Embodiments of the present invention relate to a sheet processing system.

### BACKGROUND

Conventionally, there is a sheet processing apparatus which is provided with a plurality of stackers for stacking sorting processed sheets. The sheet processing apparatus sorts and stacks sheets of a kind which has previously been associated with each of the plurality of stackers in each stacker. However, when the number of the plurality of stackers is smaller than the number of kinds of the sheets to be sorting processed, there was a possibility that proper sorting processing becomes difficult. In addition, when the number of sheets of a specific kind increases, stacking of the sheets concentrates in a specific stacker, and thereby, there was a possibility that it becomes difficult to make the apparatus effectively operate.

### PRIOR ART DOCUMENT

Patent Document 1: U.S. Pat. No. 7,735,621

### SUMMARY OF THE INVENTION

### Problem to be Solved by the Invention

A problem to be solved by the present invention is to provide a sheet processing system which can properly perform sorting processing of sheets of a plurality of kinds, while making each of a plurality of sheet processing apparatuses effectively operate.

### Means for Solving the Problem

A sheet processing system of an embodiment has a plurality of sheet processing apparatuses, a sorting apparatus, a storage unit, an information acquisition unit, and a controller. The plurality of sheet processing apparatuses each has a plurality of stackers for stacking sheets. The plurality of sheet processing apparatuses each sorts and stacks the sheets in the plurality of stackers. The plurality of sheet processing apparatuses each outputs information of a stacking status of the sheets in each of the plurality of stackers. The sorting apparatus sorts and feeds a sheet group formed of a plurality of the sheets to any of the plurality of sheet processing apparatuses. The storage unit stores the information of the stacking status of the sheets in each of the plurality of sheet processing apparatuses. The information acquisition unit acquires the information of the sheet group. The controller controls sorting of the sheet group by the sorting apparatus, based on the information of the sheet group which is acquired by the information acquisition unit, and the information of the stacking status of the sheets which is stored in the storage unit.

### BRIEF DESCRIPTION OF THE DRAWINGS

FIG. 1 A block diagram showing a configuration of a sheet processing system of an embodiment.

FIG. 2 A sectional view showing a banknote processing apparatus of the embodiment.

FIG. 3 A sectional view showing the main module, the loading module, the sealing module of the banknote processing apparatus of the embodiment as enlarged.

FIG. 4 A block diagram schematically showing the banknote processing apparatus of the embodiment.

FIG. 5 A perspective view showing the feeding portion of the banknote processing apparatus of the embodiment.

FIG. 6 A sectional view of the feeding portion of the banknote processing apparatus of the embodiment.

FIG. 7 A diagram schematically showing the feeding portions with different tilt angles of the support surface of the banknote processing apparatus of the embodiment.

FIG. 8 is a plan view showing a batch card to be used in the banknote processing apparatus of the embodiment.

FIG. 9 A sectional view showing the takeout mechanism and the conveying path in the banknote processing apparatus of the embodiment as enlarged.

FIG. 10 A sectional view showing the lowermost portion of the conveying path and the intake fan of the banknote processing apparatus of the embodiment.

FIG. 11 A perspective view showing a front side of an automatic teller machine according to the banknote processing apparatus of the embodiment.

FIG. 12 A perspective view showing a rear side of the automatic teller machine according to the banknote processing apparatus of the embodiment.

FIG. 13 A perspective view showing a bound banknote bundle (small bundle) in the banknote processing apparatus of the embodiment.

FIG. 14 A perspective view showing an example of a large banknote bundle formed by stacking and binding a plurality of small bundles in the banknote processing apparatus of the embodiment.

FIG. 15 is a diagram schematically showing a batch card processing system according to the banknote processing apparatus of the embodiment.

FIG. 16 A block diagram showing a configuration of the sheet processing apparatus of the embodiment.

FIG. 17 A diagram showing an example of processing status information of the sheet processing apparatus of the embodiment.

FIG. 18 A flow chart showing an operation example of the sheet processing apparatus of the embodiment.

FIG. 19 A flow chart showing an operation example of the sheet processing apparatus of the embodiment.

FIG. 20 A flow chart showing an operation example of the sheet processing apparatus of the embodiment.

FIG. 21 A flow chart showing an operation example of the sheet processing apparatus of the embodiment.

FIG. 22 A flow chart showing an operation example of the sheet processing apparatus of the embodiment.

FIG. 23 A sectional view showing a banknote processing apparatus according to a first modification of the embodiment.

FIG. 24 A perspective view showing the reversing device in the banknote processing apparatus according to the first modification of the embodiment.

FIG. 25 A perspective view showing the twisted belt of the reversing device of the banknote processing apparatus according to the first modification of the embodiment.

FIG. 26 A perspective view showing the reversing device of the banknote processing apparatus according to the first modification of the embodiment.

FIG. 27 A sectional view showing a banknote processing apparatus according to a second modification of the embodiment.

FIG. 28 A sectional view showing a banknote processing apparatus according to a third modification of the embodiment.

FIG. 29 A sectional view showing a banknote processing apparatus according to a fourth modification of the embodiment.

FIG. 30 A plan view schematically showing a banknote processing apparatus according to a fifth modification of the embodiment.

FIG. 31 A plan view schematically showing a banknote processing apparatus according to a sixth modification of the embodiment.

FIG. 32 A configuration diagram of a sheet collation system according to a seventh modification of the embodiment.

FIG. 33 A schematic diagram showing a schematic configuration of the sheet preprocessing apparatus according to the seventh modification of the embodiment.

FIG. 34 A flow chart showing an operation of the sheet preprocessing apparatus according to the seventh modification of the embodiment.

FIG. 35 A perspective view of a bundle B in the seventh modification of the embodiment.

FIG. 36 A perspective view of a sheaf SB and a sheet P in the seventh modification of the embodiment.

### EMBODIMENTS TO PRACTICE THE INVENTION

Hereinafter, a sheet processing system of an embodiment will be described with reference to the drawings.

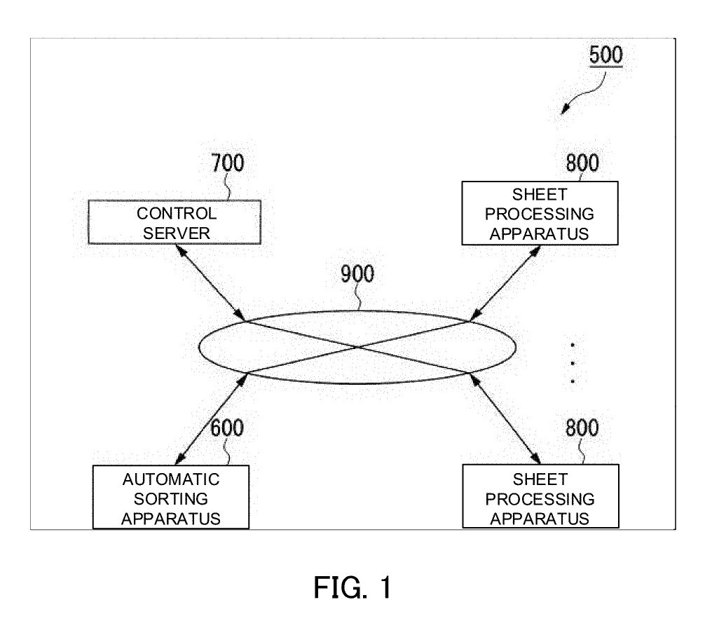

FIG. 1 is a block diagram showing a configuration of a sheet processing system 500 of an embodiment. As shown in FIG. 1, the sheet processing system 500 of the embodiment is provided with an automatic sorting apparatus 600, a control server 700, a plurality of sheet processing apparatuses 800. The automatic sorting apparatus 600, the control server 700, a plurality of the sheet processing apparatuses 800 communicate with each other via a network 900.

The automatic sorting apparatus 600 is a robot hand or the like, for example. The automatic sorting apparatus 600 sorts and conveys a sheet group composed of a plurality of loaded sheets into any of a plurality of the sheet processing apparatuses 800. The control server 700 totally controls the sheet processing system 500. The control server 700 acquires processing status information from each of a plurality of the sheet processing apparatuses 800 at any time. The control server 700 acquires information of a sheet group which the automatic sorting apparatus 600 conveys. The control server 700 sorts the sheet group into any of a plurality of the sheet processing apparatuses 800, based on the processing status information of a plurality of the sheet processing apparatuses 800, and the information of the sheet group.

Hereinafter, an embodiment of the sheet processing apparatus 800 will be described in detail with reference to the drawings. In the following, the sheet processing apparatus 800 is a banknote processing apparatus 800 which processes a banknote as a sheet, for example.

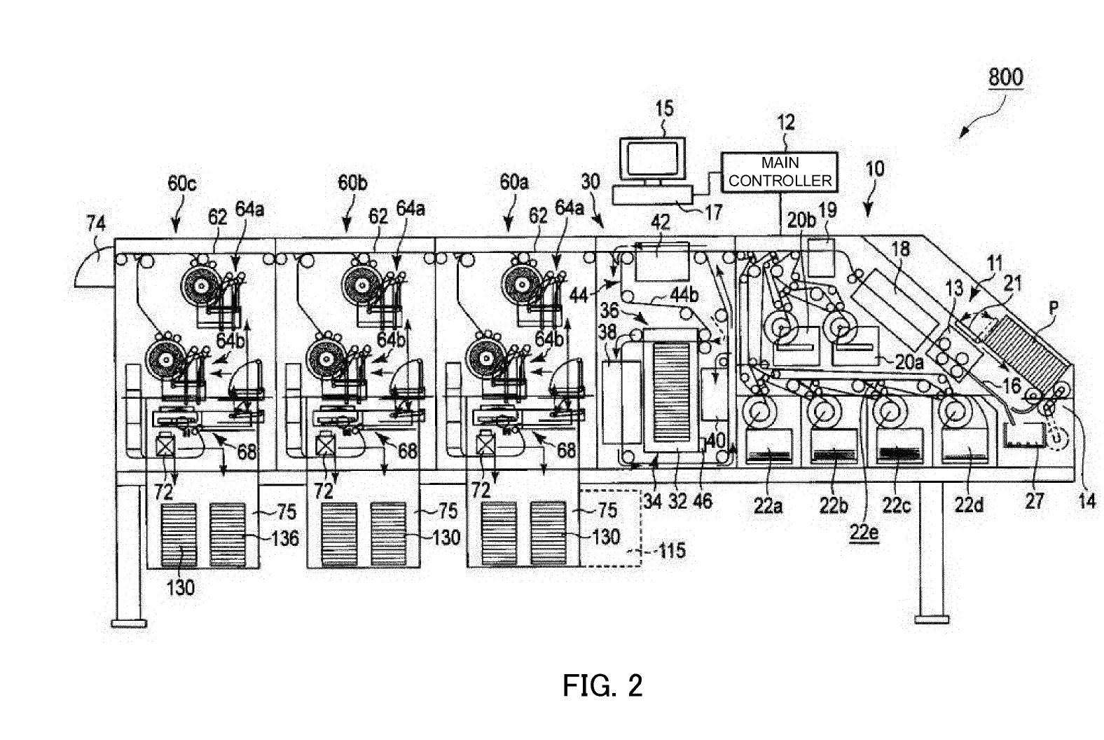

As shown in FIG. 2, the banknote processing apparatus 800 which processes a banknote as a sheet is provided with a main module 10, a loading module 30, three sealing modules 60a, 60b, 60c. These modules are arranged side by side in a line in this order, and are electrically and mechanically coupled to each other. A main controller 12 to control an operation of this main module and the whole apparatus is provided in the main module 10.

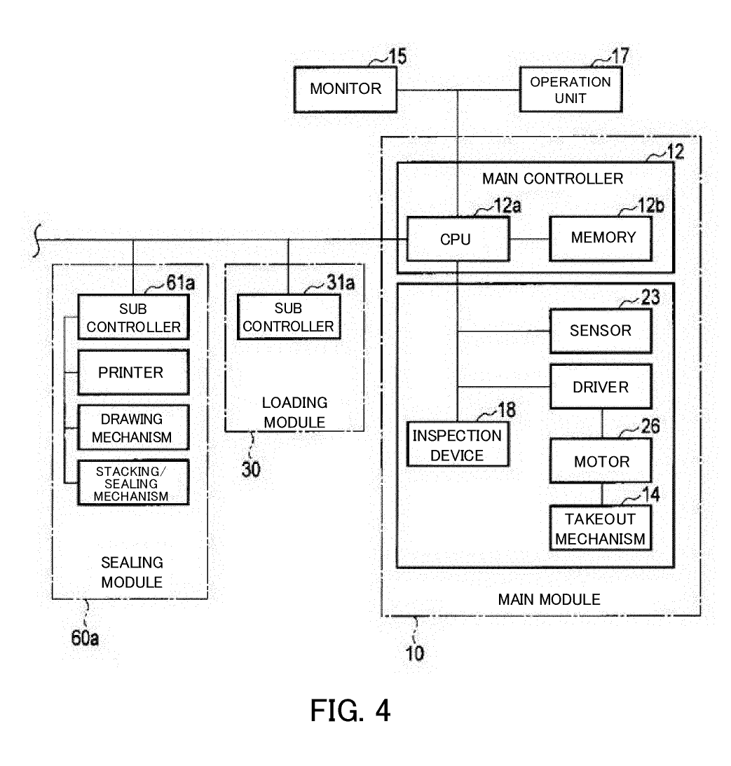

As shown in FIG. 2 and FIG. 4, the main controller 12 is provided on a control board in the main module 10. The main controller 12 is provided with a CPU 12a which controls an operation of each module and an efficiency and so on of the operation state thereof, and a memory 12b which stores various data, a control program, management information and so on. As the various data, print information printable on a binding belt, such as an operator ID described later, a date and time, a serial number, assignment information, a logo of the bank, a sign image of a manager, fonts of the languages of respective countries, and processing speeds of sheets in a plurality of stages, and so on are stored in the memory 12b.

An operation unit 17 which inputs various information to the apparatus, and a monitor 15 as a display device which displays input information and the operation state and processing state of the apparatus, and so on are connected to the main controller 12. In addition, the operation unit 17 and the monitor 15 may be formed integrally as a touch panel. The loading module 30 and the three sealing modules 60a, 60b, 60c have respectively a sub controller 31a, sub controllers 61a each of which controls an operation of the module. These sub controllers 31a, 61a are connected by means of an LAN to the main controller 12 of the main module 10 via an interface and cable not shown. The main controller 12 is connected to a host computer not shown, and performs transmission/reception of the information and information arrangement with the host computer.

Various operation settings of the processing apparatus, such as setting of a transaction method such as a money reception operation and an arrangement operation, a loading processing to a loading storage, an inspection processing of a banknote in a loading storage, setting of a stacker to store a processed banknote P, setting of a sealing processing, setting of fitness level (fitness level: Fitness Level) that is a discrimination level of a banknote, are performed by an operation of an operator from the operation unit 17 connected to the main controller 12.

In addition, the main controller 12 calculates management information including a processing efficiency per unit time, respective processing efficiencies in a plurality of days, a processing efficiency for each operator ID, the total number of the processed sheets, a total operation time, according to the processing information form an inspection device 18 described later, and stores the management information in the memory 12b, and in addition displays it on the monitor 15.

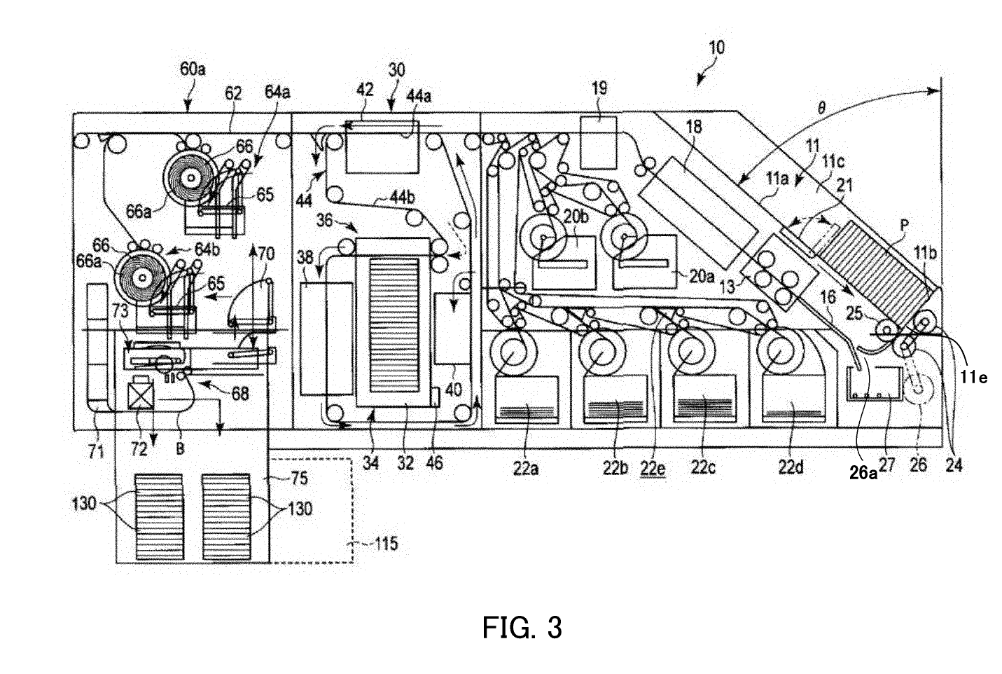

As shown in FIG. 2 and FIG. 3, the main module 10 has a feeding portion 11 in which a plurality of banknote P are loaded in a stacked state, a takeout mechanism 14 which takes out the banknotes P one by one from this feeding portion 11, and a conveying path 16 which conveys the banknote P taken out by the takeout mechanism 14. In the conveying path 16, a plurality of endless conveying belt sets not shown are arranged to extend so as to sandwich the conveying path therebetween. The taken out banknote P is conveyed while being sandwiched by the conveying belts.

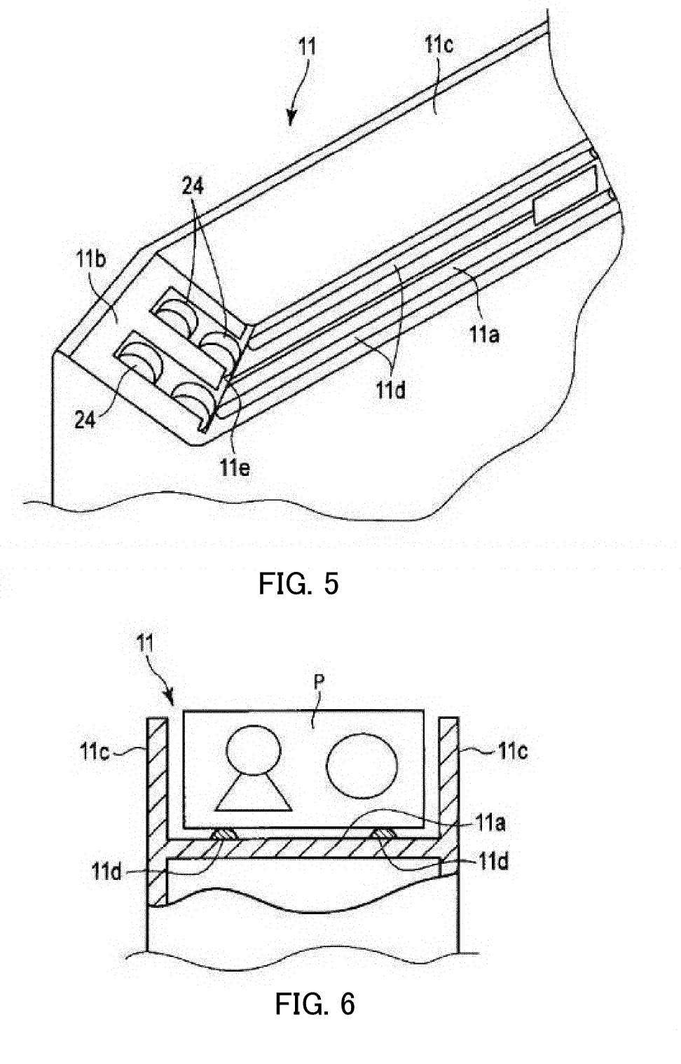

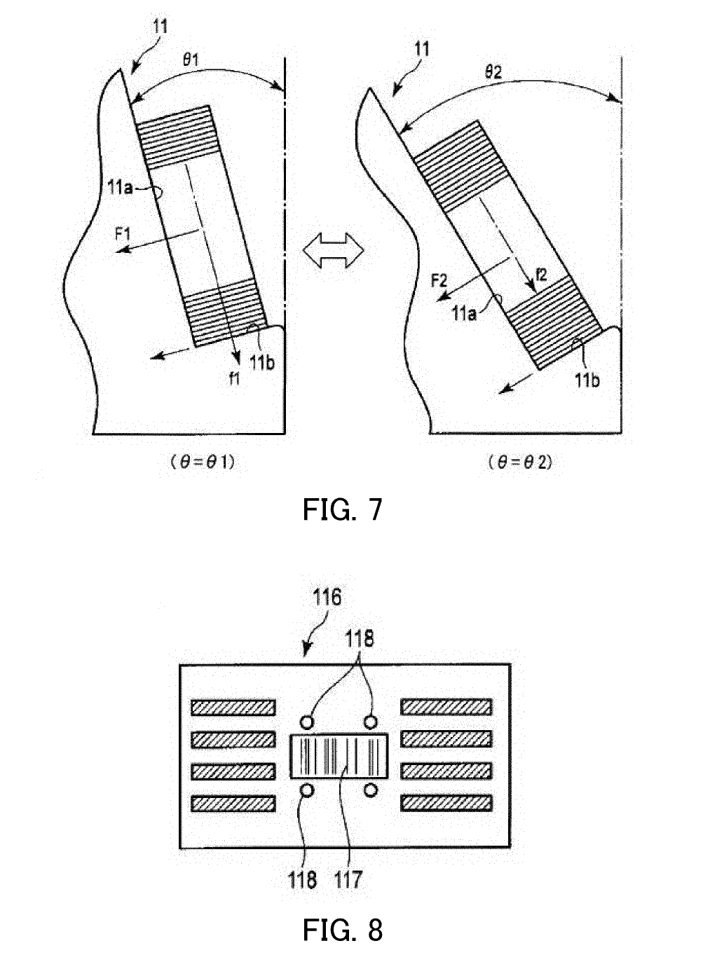

As shown in FIG. 3, FIG. 5 and FIG. 7, the feeding portion 11 has a support surface 11a extending tiltedly in the vertical direction by an angle θ, a loading surface 11b which extends from the lower end of the support surface 11a in the direction approximately orthogonal to the support surface 11a, and a pair of guide walls 11c which are erected along the both side edges of the support surface 11a and the loading surface 11b. A takeout port 11e for taking the banknote P into the apparatus is provided at a boundary portion of the support surface 11a and the loading surface 11b. This feeding portion 11 is provided at one end side of the apparatus main body of the main module 10, and the lower portion of the feeding portion 11, that is the loading surface 11b is located in the vicinity of the lower end of the apparatus main body.

It is possible to load the banknotes P of a plurality, that is not less than 2000, for example, in a stacked state in the feeding portion 11. The stacked banknotes P are tiltedly loaded in the feeding portion 11 along the support surface, in the state that the lowermost banknote is loaded on the loading surface 11b, and the side edges at the long side of the banknotes are loaded on the support surface 11a, for example. The stacked banknotes P are taken into the apparatus one by one by the takeout mechanism 14 through the takeout port 11e, in the order from the lowermost banknote P.

A tilt angle θ of the support surface 11a is set to a range from 25 to 75 degrees, and is set to 30 to 40 degrees, for example. In addition, the support surface 11a is configured to be rotatable for the apparatus main body, and the tilt angle θ thereof may be made adjustable.

FIG. 7 shows a case in which the tilt angle θ is θ1=20 degrees, and a case in which the tilt angle θ is θ2=30 degrees.

A case in which the support surface 11a is tilted against the vertical direction by the angle θ1=20 degrees, and a case in which the support surface 11a is tilted by the angle θ2=30 degrees are shown. The tilt angle of the support surface 11a is made larger, and the takeout angle of the banknote P is laid down, and thereby the weight of the stacked banknotes P against the loading surface 11b decreases (f1>f2), and the friction between the banknotes P along the stacking direction is decreased. By this means, even when the about 2000 banknotes P are stacked and arranged in the feeding portion 12, it becomes possible to stably take out the banknotes P.

On the other hand, when the tilt angle of the support surface 11a is made larger, and the takeout angle of the banknote P is laid down, the weight of the banknotes P against the support surface 11a increases (F1<F2), and the friction between the side edges of the banknotes P and the support surface 11a increases. The increase in the weight of this extent rarely affects the takeout of the banknotes P. However, in the present embodiment, in order to further decrease the friction, as shown in FIG. 5 and FIG. 6, a pair of ribs 11d is projected on the support surface 11a. These ribs 11b extend in parallel with each other, along the long direction of the support surface 11a, that is, along the stacking direction of the banknotes P. The side edges of the stacked banknotes P loaded on the feeding portion 11 are loaded on the pair of ribs 11d. For this reason, the contact area of the banknote P and the support surface 11a decreases, and thereby the friction between these can be reduced. By this means, when being taken out from the lowermost banknote P in order, the stacked banknotes P come down sequentially and smoothly toward the loading surface 11b side.

As shown in FIG. 3, the feeding portion 11 is provided with a backup plate 21 which moves the stacked banknotes P toward the takeout side, that is toward the loading surface 11b. The backup plate 21 is provided so that it can be housed on the support surface 11a and can move along the support surface. The backup plate 21 is rotatably supported with respect to the support surface 11a. When usually the about 2000 banknotes P are loaded in the feeding portion 11, for example, the backup plate 21 is rotated to the position where it is flush with the support surface 11a, and is held at the position by a torsion spring or the like. When takeout of the banknotes P proceeds, and the number of the sheets thereof decreases, for example, when the number decreases to about 800 sheets, the backup plate 21 is rotated to a position where it stands up at right angles from the support surface 11a, and then it comes in contact with the uppermost stage of the stacked banknotes P, and moves to the takeout side along with the stacked banknotes P. By this means, the backup plate 21 can move the stacked banknotes P to the takeout side, and even in the state that the number of the stacked banknotes P decreases, it is possible to prevent falling and so on of the banknote P, and banknotes P can stably be moved to the takeout position.

In addition, the sheets loaded in the feeding portion 11 may include a batch card 116 as shown in FIG. 8. This batch card 116 is formed into the same outside dimension as the banknote P, for example, or formed into an outside dimension larger than the banknote P, and a bar code 117 indicating information of a batch of the banknotes P is formed on the surface thereof and/or the rear face thereof, and the batch card 116 has a plurality of detection holes 118. In addition, the batch card is formed to be colored such as red, blue, green, and so on. The batch card 116 like this is loaded in the feeding portion 11, in the state that it is stacked at a top or a rearmost end of an optional batch in the stacked banknotes P.

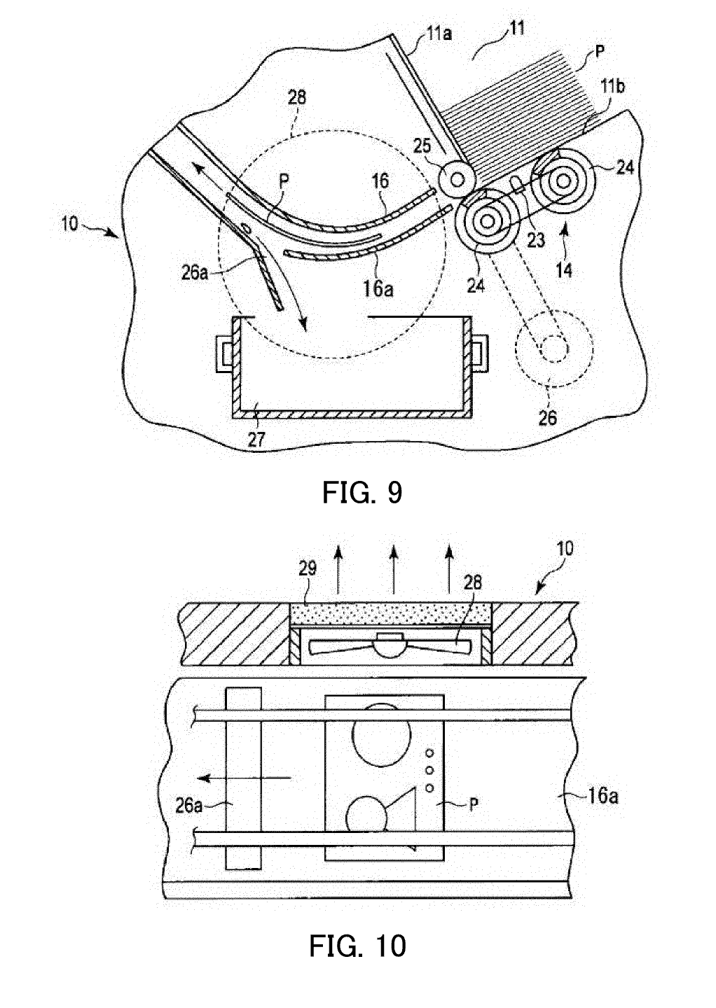

As shown in FIG. 3 and FIG. 9, the takeout mechanism 114 which takes out the banknotes P one by one from the feeding portion 11 is provided with a plurality of pickup rollers (takeout roller) 24 provided contactably with the sheet P on the loading surface 11b, a separation roller 25 which is provided so as to rotatably contact with the pickup roller 24 at the takeout hole 11e side, and a drive motor 26 which rotates the pickup roller 24 at a prescribed speed.

The pickup rollers 24 rotate, and thereby the banknote P of the lowermost stage is taken out by the pickup rollers 24, and sent to the conveying path 16 from the takeout port 11e. At this time, the second and subsequent banknotes P are separated from the taken out banknote by the separation roller 25. By this means, the banknotes P are taken out one by one from the feeding portion 11, and sent to the conveying path 16.

The main controller 12, in accordance with the amount of the loaded stacked banknotes P, or in accordance with an input instruction from an operator, adjusts the takeout amount, the takeout speed of the banknotes by the takeout mechanism 14, in a plurality of stages. That is, the main controller 12 adjusts the rotation speed of the pickup rollers 24 by the drive motor 26, and sets the take-in amount of 1000, 800, 600 sheets per minute, for example. In addition, the main controller 12 adjusts the take-in amount of the banknotes P, in accordance with the inspection state of the inspection device 18 described later. For example, when the inspection device 18 cannot perform the inspection of the banknote P well, the main controller 12 reduces the take-in amount from 1000 sheets per minute to 800 sheets per minute. Further, when the double-sheet takeout or short pitch of the banknotes P is detected by the inspection device 18, the main controller 12 makes the pickup rollers 24 to be stopped or to be reversely rotated temporarily, and thereby performs prevention of the double-sheet takeout of the banknotes P, and normalization of a feed pitch of the banknotes P.

In addition a sensor not shown to detect presence/absence of the banknote P on the loading surface 11b is provided, in the vicinity of the takeout port 11e. When the batch card 116 is used as shown in FIG. 9, an RGB sensor 23 is provided opposite to the loading surface 11b. This RGB sensor 23 detects the color of the sheet, and detects the batch card 116.

As shown in FIG. 2 and FIG. 3, a conveying pitch correction portion 13 which corrects a conveying pitch of the banknotes P to be conveyed by the conveying path 16, the inspection device 18 which inspects the banknotes P whose conveying pitch has been corrected one by one, a bar cord reader 19 are arranged along the conveying path 16. The inspection device 18 is arranged upper than the takeout port 11e of the feeding portion 11, with respect to the vertical direction. The inspection device 18 detects a denomination, a shape, a thickness, front/back, authenticity, fitness, double-sheet takeout, and so on of the banknote P which has been sent. Here, the fitness detection indicates to detect a fit note which can be recirculated, and an unfit note which has blot, break or the like and cannot be recirculated. When the batch card 116 is used, for example, the bar code reader 19 reads the bar code 117 attached to the batch card 116 which has passed through the inspection device 18, and sends the read information to the main controller 12. In addition, without providing an independent bar code reader, a configuration that the inspection device 18 reads a bar code may be used.

The conveying path 16 extends downward once from the takeout mechanism 14 and the takeout port 11e, and then extends obliquely tiltedly in the vertical direction, to the inspection device 18 from down to up. According to the present embodiment, the conveying path 16 extends approximately along the support surface 11a of the feeding portion 11, that is, extends tiltedly in the same manner as the support surface 11a. In addition, the conveying path 16 may directly extend obliquely upward from the takeout port, without going down from the takeout port 11e once. And the inspection device 18 is provided obliquely tiltedly along the conveying path 16.

Since the conveying path 16 is made to extend tiltedly from down to up in this manner, when a foreign matter such as a clip, a coin, a pin, along with a banknote P are taken in the conveying path 16, the foreign matter is made to drop to the lowermost portion of the conveying path along the conveying path 16 by the gravity. By this means, the foreign matter is excluded before entering the inspection device 18, and thereby it is possible to prevent the damage of the inspection device 18 caused by the foreign matter beforehand.

As shown in FIG. 3 and FIG. 9, a discharge port 26a is formed in a guide plate 16a which defines the conveying path 16 at the lowermost portion of the conveying path 16, and further, a foreign matter recovery portion is provided below this discharge port 26a. The foreign matter recovery portion is composed of a recovery box 27 drawable from the apparatus main body. A foreign matter which drops along the conveying path 16 is discharged from the discharge port 26a and is recovered in the recovery box 27.

As shown in FIG. 9 and FIG. 10, an intake fan 28 is provided opposite to the lowermost portion of the conveying path 16, and further, a dust collection filter 29 is provided at the discharge side of the intake fan 28. The inside of the lowermost portion of the conveying path 16 is sucked by the intake fan 28, and thereby paper powder, paper dust and so on which are generated in the conveying path 16 are removed from the conveying path, and are captured by the dust collection filter 29. By this means, the pollution of the conveying 16 and the reduction in the inspection accuracy in the inspection device 18 caused by the paper powder and so on are prevented.

As shown in FIG. 2 and FIG. 3, in the main module 10, two reject portions 20a, 20b are provided along the conveying path 16, and a plurality of stackers 22a, 22b, 22c, 22d each of which stacks banknotes therein are arranged side by side. The banknotes P which have passed through the inspection device 18 are sorted into a reject note and a processed note, by a gate not shown. The reject note means a note which has been discriminated as a counterfeit note, or a note which has been discriminated as un-discriminable, due to folding, break, skew, double-sheet takeout and so on, by the inspection device 18. Skew means a state that the banknote P is obliquely tilted in the direction orthogonal to the conveying direction. Reject notes are sorted and stacked in the reject portion 20a or 20b. The reject notes which have been stacked in the reject portion 20a or 20b, except the counterfeit note, are set in the feeding portion 11 again and are taken in again, or counted in the count data by manual input. The inspection result of a processed amount of money and the number of banknotes and so on by the inspection device 18 is sent to the main controller 12 and stored therein, and is displayed on the monitor 15.

In addition, the processed note means a note in which the banknote P discriminated by the inspection device 18 is a genuine note and a fit note, or is a genuine note and an unfit note. The processed notes are sent and stacked in the stackers 22a to 22d. For example, the processed notes are sorted and stacked in any of the corresponding stackers 22a to 22d for each denomination, and the unfit notes are collectively stacked in one stacker. In addition, a plurality of gates 22e are provided at the front stages of the stackers 22a to 22d. The gate 22e operates based on the control of the main controller 12, and thereby can make the processed note to be conveyed to a prescribed stacker. That is, the gates 22e and the conveying paths 16 at the front stages of the stackers 22a to 22d function as sorting processing means.

When the batch card 116 described above is used, after having passed through the inspection device 18 and the bar code reader 19, the batch card 11 is sent to the reject portion 20a or 20b, and is stacked therein.

The conveying path 16 connects to the loading module 30 described later. When the banknotes are loaded in a loading storage by the loading module 30, a part or all of the processed notes which have been inspected by the inspection device 18 of the main module 10 are sent to the loading module 30 through the conveying path 16.

In addition, the main module 10 is provided with a drive mechanism not shown for driving the takeout mechanism 14, the inspection device 18, the conveying mechanism, and so on, and a power source and various sensors.

As shown in FIG. 2 and FIG. 3, the loading module 30 is provided with a loading portion 34 in which a loading storage 32 such as an ATM cassette taken out from an automatic teller machine (ATM), a loading cassette is to be detachably loaded, a loading and takeout mechanism 36 which loads a banknote in the loading storage 32, or takes out a banknote from the loading storage 32, an inspection device 38, a reject storage 40, an alignment mechanism 42, and a conveying path 44 which conveys a banknote through these. On the conveying path 44, a plurality of endless conveying belt sets are arranged to extend so as to sandwich the conveying path therebetween. A banknote is conveyed while being sandwiched by the conveying belts. The conveying path 44 has a first conveying path 44a which continues from the conveying path 16 of the main module 10 to the sealing module 60a, and a second conveying path 44b which returns from the first conveying path to the first conveying path through the vicinity of the loading portion 34, the inspection device 38, the reject storage 40.

As the loading storage 32 to be loaded in the loading portion 34, there is a loading storage capable of only loading a banknote (money reception), a loading storage capable of only taking out a banknote (money payment), or a loading storage capable of loading and taking out a banknote (money reception/payment). Here, the loading storage 32 is configured such that a lot of banknotes can be loaded therein and a banknote can be taken out from this loading storage. In addition, the loading storage 32 is provided with a sensor which detects loading, takeout of a banknote, and a memory which stores information such as a note kind and an amount of money (an amount in hand) of banknotes loaded therein, operator information, ID (a branch number, an index indicating what loading storage) of the loading storage 32, a machine number.

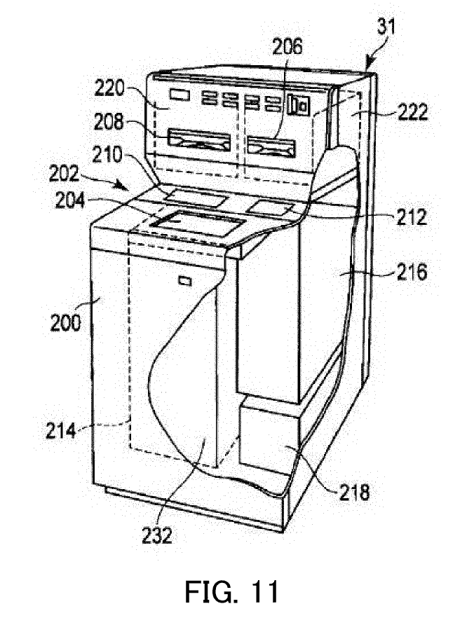

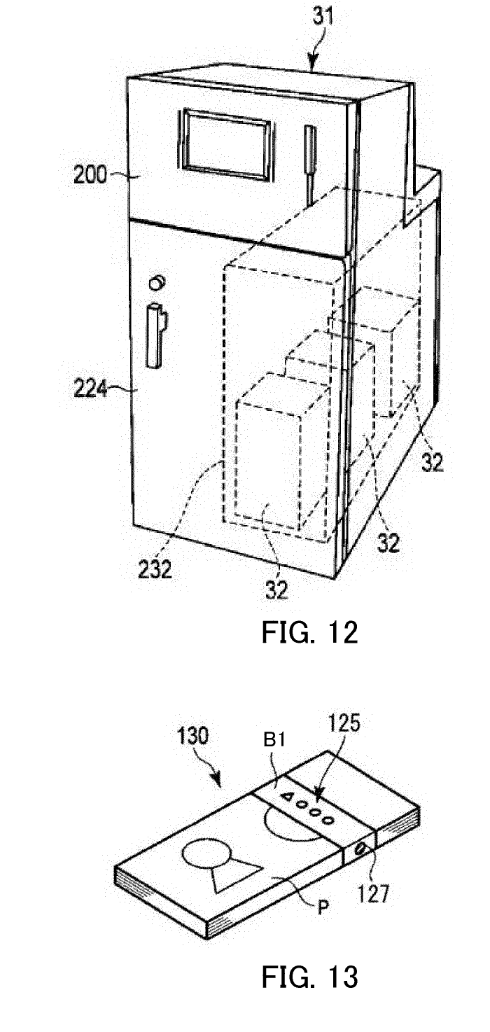

FIG. 11 and FIG. 12 show an example of an automatic teller machine (ATM). This ATM 31 is provided with a main body 200 of an approximate rectangular box shape, and an approximately L-shaped customer panel 202 facing a user is provided at the front of the main body. A display portion 204 doubling as a touch panel is provided on the horizontal portion of the customer panel 202, and a card insertion port 206, a passbook insertion port 208 and so on are provided on the vertical portion. In addition, at the corner portion of the customer panel 202, a banknote reception/payment port 210 and a coin reception/payment port 212 each of which is opened and closed by a door are provided.

In the main body 200, a banknote handling device 214 for performing reception/payment of a banknote to a user through the banknote reception/payment port 210, and a coin handling device 216 for performing reception/payment of a coin through the coin reception/payment port 212, a control unit 218, a passbook printer 220, a card/slip processing device 222 and so on are arranged.

On the back face of the main body 200, an openable/closable door 224 for enabling the takeout of the banknote handling device 214 and the coin handling device 216 from the main body is provided. An insert port 226 opposite to a banknote carry-in/carry-out portion described later of the banknote handling device 214 is formed in this door 224, and this insert port 226 is opened and closed by a door 228 which opens up and down. In addition, a connector 230 is provided on the back face of the banknote handling device 214, and faces the insert port 226.

The banknote handling device 214 has an elongated box shaped chassis 232, and in this chassis, two loading storages each for housing ten-thousand-yen notes, and a loading storage for housing thousand-yen notes are provided as the loading storages 32, side by side. The door 224 is opened and the chassis 232 is drawn out, and thereby these loading storages 32 can be detached from the chassis 232, and can be loaded in the chassis 232. In addition to this, in the chassis 232, a banknote stacking portion which receives a banknote inserted from the banknote reception/payment port 210 and pays a payment banknote, a money reception temporarily stacking portion which temporarily stacks reception banknotes, an inspection portion which inspects a reception banknote and a payment banknote, a pair of reject storages to house reject banknotes, a recovery storage to house an unfit note or the like, and so on are provided.

The loading storage 32 taken out from the ATM 31 like this is detachably loaded in the loading portion 34 of the loading module 30. The loading storage 32 is loaded in the loading portion 34, and thereby the loading storage 32 is connected to the loading and takeout mechanism 36, and is connected to the controller of the loading module 30 via a connector 46. The information stored in the memory of the loading storage 32 is sent to the main controller 12 via the connector 46 and the LAN. A radio frequency individual identification (RFID) such as a radio IC tag is given to the loading storage 32, and the information of the loading storage 32 may be transmitted to the loading module 30 and the main controller 12 by radio communication.

The loading and takeout mechanism 36 of the loading module 30 has a takeout roller which takes out banknotes one by one from the loading storage 32, a loading roller which loads a banknote to the loading storage 32, and a conveying belt and so on.

The inspection device 38 detects a denomination, a shape, a thickness, front/back, authenticity, fitness, double-sheet takeout, a serial number of a banknote, and so on of the banknote which has been taken out from the loading storage 32. Here, the fitness detection indicates to detect a fit note which can be recirculated, and an unfit note which has blot, break or the like, and cannot be recirculated. The unfit note includes a banknote to which a tape has been pasted. As the authenticity detection, magnetic detection, image detection or fluorescence detection to read reflected light by applying fluorescent light can be used. In addition, the inspection device 38 counts the taken out banknotes, and calculates the number of the banknotes and an amount of money in hand. The inspection result of an amount of money in hand and the number of banknotes and so on detected by the inspection device 38 is sent to the main controller 12 and stored therein, and is displayed on the monitor 15.

The reject storage 40 is provided at the downstream side of the inspection device 38, with respect to the conveying direction of the banknote, by a gate not shown. The banknotes P which have passed through the inspection device 38 are divided into a reject note and a processed note. The reject note means a note which has been discriminated as a counterfeit note, or a note which has been discriminated as un-discriminable due to folding, break, skew, double-sheet takeout and so on, by the inspection device 38. Reject notes are sent to the reject storage 40 and stacked therein. In addition, under the control of the main controller 12, any one or a plurality of the stackers 22a-22d of the main module 10 have been set as the reject storages in advance, and the reject note discharged from the loading module 30 may be sent to and stacked in the reject storage of the main module 10. Further, out of the reject notes which have passed through the inspection device 38, the reject note which has been discriminated as a counterfeit note and other reject note may be separately stacked in different reject storages.

The processed note means a note in which the banknote P discriminated by the inspection device 38 is a genuine note and a fit note, or a genuine note and an unfit note. The fit note is returned to the loading storage 32 through the conveying path 44b and the alignment mechanism 42, and is loaded in the loading storage 32 by the loading and takeout mechanism 36. Under the control of the main controller 12, any one or a plurality of the stackers 22a-22d of the main module 10 have been set as unfit note storages in advance, and the unfit note discharged from the loading module 30 may be sent to and stacked in the unfit note storage of the main module 10.

The fit notes taken out from the loading storage 32 may be stacked in the stackers 22a-22d of the main module 10 by an optional designated number of sheets which has been previously set for each denomination. In addition, when the number of the banknotes to be stacked in the loading storage 32, that is 2000 is set, for example, the deficient amount can be recognized from the number of the fit notes detected by the inspection device 38 as described above, and the banknotes of the deficient number are fed from the main module 10 to the loading module 30, and are loaded in the loading storage 32 through the alignment mechanism 42 and the conveying path 44. The loading storage 32 is loaded in the loading portion 34 of the loading module 30, and thereby the amount of money in hand of the banknotes in the loading storage 32 is automatically sent to the main controller 12, and accordingly, when judging that the sent amount of money in hand is deficient for the desired amount of money in hand, the main controller 12 may automatically feed and load the banknotes of the deficient amount from the main module 10 in the loading storage 32.

The information of the banknote which have been loaded from the main module 10 in the loading storage 32 is stored in the memory of the loading storage 32, and is electronically sealed. When the loading storage 32 is taken out from the loading module 30, and a lid thereof is opened, door open information and day and date are stored in the memory. As the electronic seal, a password or an IC card can be used, and when an electronic key or an IC card is used at the time of opening the door of the loading storage 32, the information of an operator who has used it is also stored in the memory. By this means, it is possible to enhance the security of the loading storage 32.

In addition, the information acquired from the loading storage 32, such as a store number of the ATM, operator information, a note kind, an amount of money, a loading direction, an amount of loaded banknotes, a transportation route of the loading storage is sent to the main controller 12, and is recorded and totaled up in the main controller 12. In the operator information, an operator at the ATM store side, and an reception operator who sets the loading storage 32 into the banknote processing apparatus are included. The information of the loading storage 32 like this is managed by the main controller 12, and thereby it becomes possible to achieve the improvement of the security.

On the other hand, when the sealing processing of banknotes has been set, the fit notes taken out from the loading storage 32 are sent to the sealing module 60a through the conveying path 44 and the alignment mechanism 42, and sealed for each prescribed number of sheets. The alignment mechanism 42 aligns the center of the banknote to be sent through the conveying path 44 with the center of the conveying path, and corrects the skewed banknote so that one side thereof is directed in the direction orthogonal to the conveying direction.

As shown in FIG. 2 and FIG. 3, the sealing module 60a as the stacking and sealing device is provided with a conveying path 62 which communicates with the conveying path 44a of the loading module 30, a first stacking device 64a and a second stacking device 64b each of which stacks the banknotes which have been sent through this conveying path 62 for each prescribed number of sheets, a sealing device 68 which seals a bundle of the banknotes stacked by each of the stacking devices by the prescribe number of sheets, 100 sheets, for example, by a belt. The second stacking device 64b is arranged shiftedly in the obliquely downward direction of the first stacking device 64a, and the sealing device 68 is arranged below the second stacking device 64b. Further, a discharge portion 75 which receives and stacks the banknote bundle sealed by the sealing device 68 is provided below the sealing device 68.

Each of the first and second stacking devices 64a, 64b is provided with a temporary stacking portion 65, and an impeller stacking device 66 which stacks the sent banknotes P one by one in the temporary stacking portion 65 by a prescribed number of sheets. An impeller 66a of the impeller stacking device 66 in which a plurality of blades are assembled around the rotation axis thereof, is rotated in synchronization with the conveying of the banknotes, so that the sent banknote P can be received between the blades. This impeller 66a is used, and thereby while absorbing the motion energy of the banknotes P to be conveyed at a high speed, and while aligning the banknotes P, stacks the banknotes P in the temporary stacking portion 65.

The sealing module 60a is provided with a conveying tray 70 which is liftable/lowerable, and movable in the lateral direction, and receives stacked banknotes from each of the first and second stacking devices 64a, 64b, and conveys the received banknotes for the sealing device 68.

The sealing device 68 is provided with a belt feeding portion 71 which feeds a binding belt (a first belt) B for sealing the banknote bundle of 100 sheets conveyed by the conveying tray 71, a printer 72 which prints desired information on the fed binding belt, a belt winding mechanism 73 which winds the printed binding belt B1 around the banknote bundle, an adjustment mechanism 76 which adjusts the winding position of the biding belt B1 to the banknote bundle.

As the printer 72, an ink jet printer, a dot printer, a laser printer or the like can be used. The printer 72 prints, under the control of the main controller 12 and the sub controller 61a, optional information inputted by an operator, or an operator ID, a date and time, a serial number, assignment information, a logo of the bank, a sign image of a manager and so on which are stored in the memory 12b, on the binding belt B1 with an optional language font.

FIG. 13 shows a banknote bundle (a small bundle) 130 of 100 sheets which has been sealed by the sealing module 60a. A binding belt B1 is wound around at an optional position, and desired information 125 is printed on the binding belt B1. Further, a confirmation stamp 127 of an operator may be pressed on a side portion of the binding belt B1, that is, on a portion extending in the thickness direction of the banknote bundle 130.

As shown in FIG. 3, the banknote bundle 130 which has been stacked and sealed as described above is discharged to the discharge portion 75, and the banknote bundles 130 are sequentially housed in a stacked manner. As described above, the sealing module 60a seals the fit notes sent from the main module 10, or the fit notes which are taken out from the loading storage 32 and sent from the loading module 30, by a prescribed number of sheets for each denomination, and feeds the sealed banknote bundle.

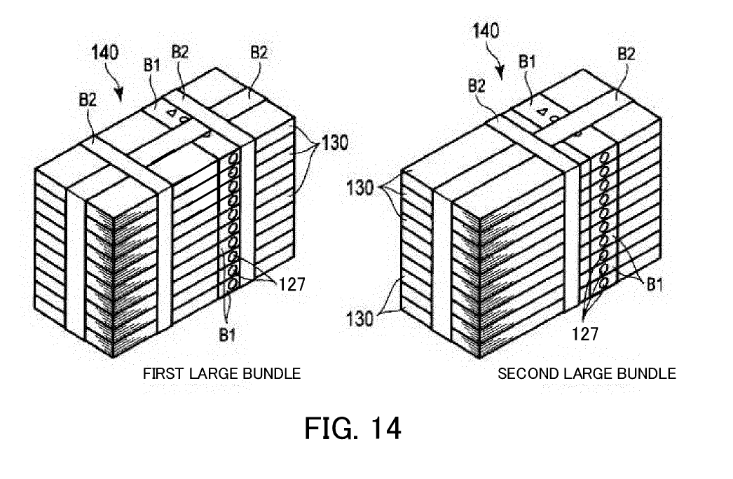

As shown in FIG. 3, the sealing module 60a may be provided with a large bundle sealing device 115 which stacks the banknote bundles 130 housed in the discharge portion 75 by a plurality of bundles, and binds them with a large belt to form a large banknote bundle. As shown in FIG. 14, a plurality of, that is ten, for example, banknote bundles 130 are stacked and bound with a plurality of binding belts (second belt) B2, and thereby a large bundle 140 is formed.

The first large bundle 140 shown in FIG. 14 is bound with the one binding belt B2 in the long direction, and with the two binding belts B2 in the lateral direction. The second large bundle 140 shown in FIG. 14 is bound with the one binding belt B2 in the long direction, and with the one binding belts B2 in the lateral direction. In any of the large bundles 140, the binding belt B1 of each small bundle 130 is wound at a position shifted from the binding belt B2 of the large bundle 140, that is at a position where it does not overlap with the binding belt B2. For the reason, in the large bundle 140, the side face portion of the binding belt B1 of each small bundle 130 is not hidden by the binding belt B2, but is exposed to the outer surface of the large bundle. By this means, after the large bundle 140 is formed, it is possible to press the confirmation stamp 127 on the side face portion of the binding belt B1 of each small bundle 130. Or even when the confirmation stamp 127 has been previously pressed on the side face portion of the binding belt B1, it is possible to visually recognize the confirmation stamp 127 from the outside, after the large bundle 140 is formed.

According to the banknote processing apparatus, the small bundles formed by the sealing module are collected by 10 sheaves (10 small bundles), and are bound with a large belt and sealed into a large bundle by the large bundle sealing device, and then a radio tag (RFID tag) storing information from the banknote processing apparatus is attached to the large bundle, and the information may be linked between the banknote processing apparatus and the large bundle.

As shown in FIG. 2, the other sealing modules 60b, 60c are configured in the same way as the sealing module 60a, and the conveying paths 62 of the respective sealing modules 60a, 60b, 60c extend while communicating with each other. And the banknotes P are sent from the main module 10 or the loading module 30 to an optional one of the sealing modules 60a, 60b, 60c, and are stacked and sealed therein.

A safety box 74 is provided at the most downstream position of the all modules. When a banknote which cannot be processed while being conveyed through each module exists, this banknote is discharged to the safety box 74, and evacuated from the apparatus.

In addition, the loading storage 32 which banknotes have been recovered from or replenished to by the banknote processing apparatus as described above, is detached from the loading module 30 after the processing, and loaded in the corresponding ATM.

A batch processing of a banknote group using a batch card 116 will be performed as in the following.

For example, in the case of processing a first stacked banknote group (a first batch) and a second stacked banknote group (a second batch), as shown in FIG. 3, in the state that a batch card (with bar code) 116 is previously inserted at the rearmost of each money reception batch, a plurality of the batches are stacked, and then the stacked banknote groups and batch cards are collectively set in the feeding portion 11 of the processing apparatus, and then they are continuously taken in.

A number specific to the banknote group (batch) or the like is printed on the batch card 116 with a bar code 117, as shown in FIG. 8, and the bar code can be read by a bar code reader provided on the conveying path. The RGB sensor 23 is provided opposite to the loading surface 11b, and this RGB sensor 23 detects a color of the sheet, and thereby detects the batch card 116. The bar code reader 19 reads the bar code 117 attached to the batch card 116 which has passed through the inspection device 18, and sends the read information to the main controller 12. In addition, without providing an independent bar code reader, a configuration in which the bar code is read by the inspection device 18 may be used.

The inspection device 18 detects passage of the batch card 116, recognizes the boundary between the money reception batches, and counts a sum of money of the relevant money reception. After having passed through the inspection device 18 and the bar code reader 19, the batch card 116 is sent to the reject portion 20a or 20b, and is stacked therein. As a result, since a reject banknote which has been rejected during the processing comes to be stacked between the batch card 116 of the money reception batch to which the reject banknote belongs and the batch card 116 of the immediately preceding batch, it becomes possible to identify the batch to which each reject banknote belongs. In the batch processing, it is possible to re-feed (mechanical re-counting) the reject banknote to the feeding portion 11 after the first count has been finished.

The batch processing is configured such that two kinds of a secure continuous mode and a full continuous mode can be selected.

In the secure continuous mode, a batch card is inserted at the rearmost of a banknote group, and thereby a continuous processing is performed without stopping the processing operation between a plurality of batches as far as possible. After the batch card is detected, take-in of the next batch is stopped till the counting is determined.

In the full continuous mode, a batch card is inserted at the rearmost of a banknote group, and thereby a continuous processing is performed without stopping the processing between a plurality of batches as far as possible. Even when the batch card is detected, next take-in is not stopped.

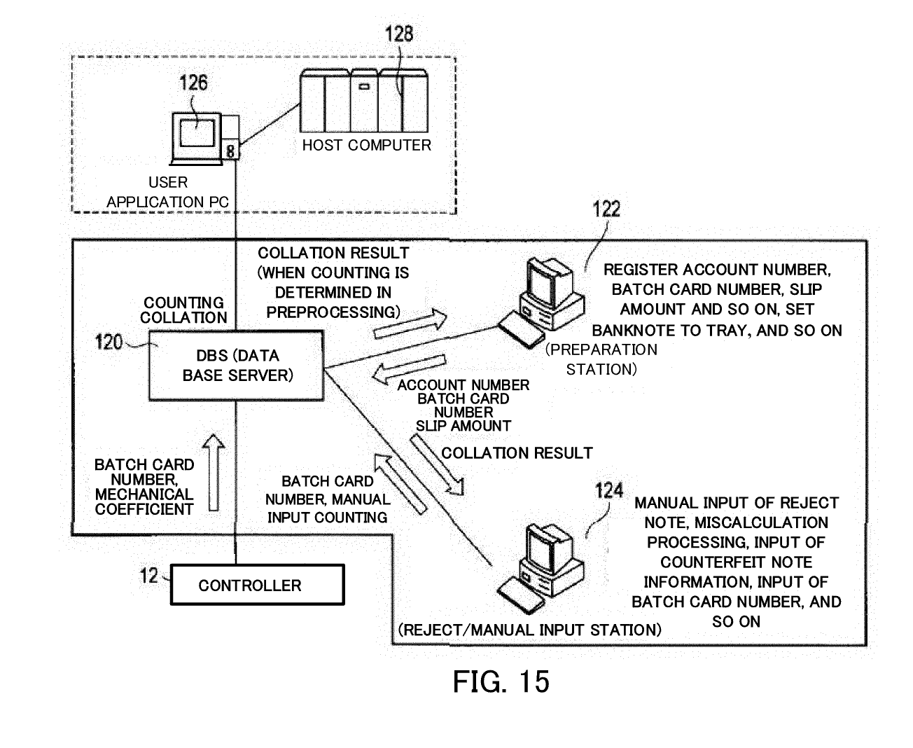

FIG. 15 shows an example of a batch card system which manages banknote processing using the data of the above-described batch card. This system is provided with a database server 120, a preparation station 122 and a reject/manual input station 124 which are connected to the database server. In addition, the database server 120 is connected to a user application computer 126, and this computer is connected to a host computer 128 via a network. The batch card number and the mechanical counting data are sent from the main controller 12 of the sheet processing apparatus to the database server.

The preparation station registers an account number, a batch card number, a slip amount, and sends the account number, the batch card number, the slip amount to the database server, and instructs loading of the banknote group in the feeding portion 11. The reject/manual input station performs manual input of information of a reject note, miscalculation processing, input of counterfeit note information, manual input of a batch card number, and so on, and sends the inputted batch card number, manual input count to the database server.

The database server counts and collates the batch card number and the mechanical counting data which have been sent from the main controller 12 of the sheet processing apparatus, the account number, the batch card number, the slip amount which have been sent from the preparation station, and the batch card number, the manual input counting which have been inputted from the reject/manual input station, and sends the collation result to the preparation station and the reject/manual input station. By this means, whether or not mechanical counting of the sheet group subjected to the batch processing is accurately performed is monitored in accordance with the batch card number.

On the other hand, when a jam of a banknote occurs in any of the above-described banknote processings, a jam processing will be performed as in the following. In order to form load of an operator when a jam occurs, the following request is incorporated.

When a jam occurs, the portion which can continue the conveyance, out of the stackers 22a-22d of the main module 10 and the sealing modules 60a, 60b, 60c, does not stop conveying a banknote, but finishes the conveying to the stacker and the sealing stacking portion. When finishing the stacking of the banknotes P, the sealing module performs the sealing operation. A shift mistake is regarded as a conveying jam of the generating part.

The sealing module finishes the conveying of the all banknotes, when regarding the banknotes which have entered within the module, conveying of such banknotes to the sealing stacking portion can be finished and such banknotes can be stacked in the sealing stacking portion, and in addition, when regarding the banknotes to be conveyed to the sealing module at the downstream side, the conveying path of the downstream side sealing module is operable, and the sealing module performs the sealing operation when the stacking number in the sealing stacking portion reaches 100, and then stops. When even one banknote whose conveying cannot be finished exists, the conveying is immediately stopped, and the banknote is to be brought back.

The banknotes which have been stacked in the sealing module are surely reflected to the counting. When a jam occurs in the sealing module, the sealing conveying is stopped immediately. The sealing mechanical portion finishes the sealing operation when a prescribed number of or 100 banknotes are stacked, and stops after charging the sheaf. The portions whose sealing has been finished and which have been discharged are reflected to the number of cases.

After an operator removes a residual banknote due to a jam in the sealing module, the banknote in the sealing module is automatically conveyed to the safety box by a teller operation of the operator, and the banknotes stacked in the safety box and the both sealing stacking portions are recovered. The sealing module finishes the conveying of the all banknotes, when a jam occurs outside the sealing module, when conveying of banknotes to the sealing stacking portion can be finished and the banknotes can be stacked in the sealing stacking portion, and in addition, when regarding the banknotes to be conveyed to the sealing module at the downstream side, the conveying path of the downstream side sealing module is operable, and the sealing module performs the sealing operation when the stacking number in the sealing stacking portion reaches 100, and then stops. At this time, a conveying timing of the banknote is checked after a jam has occurred, and when the banknote has been conveyed in a timing longer than an estimated time, it is judged that a jam has occurred. In this case, the banknotes which have been stacked in the sealing stacking portion are to be brought back.

When even one banknote whose conveying cannot be finished exists, the conveying is immediately stopped, and the banknotes in the sealing module are to be brought back. However, when the stacking becomes impossible, the sealing conveying is immediately stopped. After the cause of the jam is removed, the residual banknotes in the sealing module are automatically conveyed to the sealing stacking portion by a teller operation of an operator, and the banknotes stacked in the both sealing stacking portions are recovered.

In order to reduce an operation of an operator after the jam processing, the residual banknotes may automatically be discharged. In this case, after an operator has performed a jam processing of a generating part of a conveying jam, while the residual banknotes are left in the conveying path, the banknote is conveyed at a normal speed, and is stacked in any of the reject storage, the stacking storage, the safety pocket. The banknotes stacked in the temporary storage at this time are all brought back. The operation is performed by a teller operation of an operator, after the jam is released. The door opening operation of the generating part of the conveying jam and the conveying monitoring during conveying are performed, so that a failure such as the detachment of a conveying belt is not generated.

According to the banknote processing apparatus configured as described above, the loading storage 32 detached from an ATM is loaded in the loading portion 34 of the loading module 30, and thereby the banknotes in the loading storage can be automatically taken in and arranged in the banknote processing apparatus. In addition, the banknote taken out from the loading storage 32 is passed through the inspection device 18, and thereby discrimination of the note kind, authenticity, fitness and so on of the banknote can be performed, and the banknote is returned to the loading storage, and thereby the amount of money in hand in the loading storage can be detected. That is, it is possible to perform a scrutiny processing to scrutinize the banknote in the loading storage 32 and return it again to the loading storage. The banknotes taken out from the loading storage 32 are sent to the sealing modules 60a-60c, and thereby a sealing processing to a small bundle of 100 sheets can be performed. Further, when the loading storage 32 of the automatic teller machine has a loading function, the loading storage 32 is set in the banknote processing apparatus, the banknotes inputted in the main module 10 can be automatically loaded in the loading storage by a desired number of the banknotes and of a desired note kind. And, since these various processings can be performed without opening the lid of the loading storage 32, it is possible to enhance the security. The information can be transferred between the loading storage 32 and the banknote processing apparatus, and thereby the management of an amount of money in hand can be performed bi-directionally. Further, a journal printer to print out a transaction journal is provided in the loading module 30, if necessary, and this transaction journal may be attached to the loading storage 32.

The loading storage 32 to be loaded in the loading module 30 is a loading storage for the exclusive use of money payment, it is not possible to load the banknotes directly in the loading storage by the takeout loading mechanism. Therefore, in this case, a temporary stacking portion to stack the banknotes taken out from the loading storage, or the banknotes sent from the main module 10, and a robot hand to hold the banknotes of 500 sheets, for example, stacked in this temporary stacking portion and pack them into the loading storage 32 are provided in the loading module 30, and thereby loading processing can be performed.

Since the feeding portion 11 of the main module 10 is provided obliquely in the vertical direction, the friction between the loaded stacked banknotes can be reduced, and it is possible to prevent a slip, a following takeout, a double-sheet takeout and so on when the banknote is taken out. By this means, even when a large number of banknotes are arranged in a stacked state, it is possible to stably take out and process the banknotes one by one, and thereby it is possible to achieve the improvement of reliability. In addition, since the loading portion 11 is provided at a relatively low position in the main body of the apparatus, it is possible to easily perform a loading operation of the sheets to the loading portion 11.

Further, even when a foreign matter is taken in, the foreign matter can be discharged and removed before it is carried to the inspection device, and thereby it is possible to prevent a damage of the inspection device caused by a foreign matter, and thereby the improvement of the banknote processing apparatus can be achieved.

Hereinafter, an operation of the sheet processing system 500 of the embodiment will be described in detail with reference to the drawings.

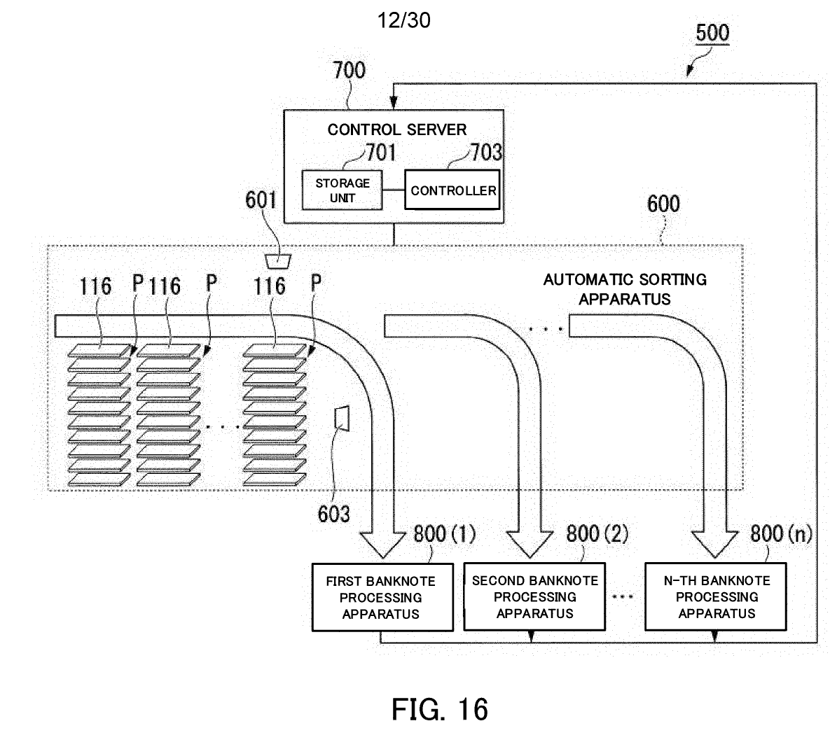

As shown in FIG. 16, the control server 700 is provided with a storage unit 701 and a controller 703. The controller 703 is provided with a CPU, a ROM, and a RAM. The controller 703 of the control server 700 sorts a banknote group to any of the banknote processing apparatuses 800, based on the processing status information of a plurality of the banknote processing apparatuses 800, and the information of the banknote group. A plurality of the banknote processing apparatuses 800 shown in FIG. 16 are a first banknote processing apparatus 800(1), . . . , an n-th banknote processing apparatus 800(n) corresponding to an optional natural number n, for example. Each of a plurality of the banknote processing apparatuses 800 outputs the processing status information to the control server 700 at any time.

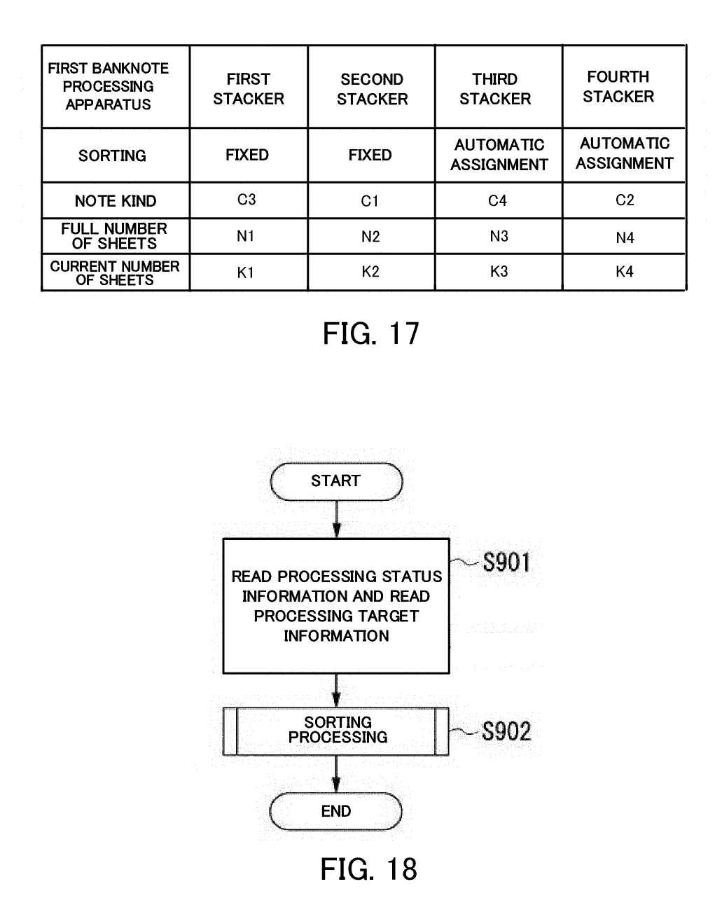

The control server 700 acquires the processing status information from each of a plurality of the banknote processing apparatuses 800 at any time. The storage unit 701 of the control server 700 stores the processing status information in each of a plurality of the banknote processing apparatuses 800. The processing status information is information such as a sorting processing in each of a plurality of stackers in each of the banknote processing apparatuses 800. a note kind assigned to each stacker, a full number of sheets in each stacker, and a current number of sheets in each stacker, as shown in FIG. 17. The sorting processing of each stacker is a fixed processing, and an automatic assign processing, and so on. The fixed processing is a processing in which a note kind to be stacked in each stacker is fixed previously. The automatic assign processing is a processing in which a note kind to be stacked in each stacker is automatically and dynamically changed for each a series of stacking operation. In the automatic assign processing, the banknotes are stacked till the stacker becomes full, and then when the stacked banknotes are removed, the setting of the note kind which has been associated with the stacker at this time is erased, and the note kind to be newly set is associated with the stacker.

The first banknote processing apparatus shown in FIG. 17 is provided with four stackers, for example. The fixed processing is performed to the first stacker and the second stacker. The automatic assign processing is performed to the third stacker and the fourth stacker. In the first stacker, banknotes P of a third note kind C3 are stacked by a current number K1 of sheets for a full number N1 of sheets. In the second stacker, banknotes P of a third note kind C1 are stacked by a current number K2 of sheets for a full number N2 of sheets. In the third stacker, banknotes P of a fourth note kind C4 are stacked by a current number K3 of sheets for a full number N3 of sheets. In the fourth stacker, banknotes P of a second note kind C2 are stacked by a current number K4 of sheets for a full number N4 of sheets.

The control server 700 acquires the information of the banknote group which the automatic sorting apparatus 600 conveys, based on the detection signals of various sensors. The banknote group is provided with a plurality of banknotes P which are stacked for each processing unit. The various sensors are a first sensor 601 which detects the information given to each banknote group, for example, and a second sensor 603 which detects the state of a plurality of the banknotes P composing the banknote group, and so on.

The first sensor 601 is a bar code reader which reads a bar code attached to the batch card 116 given for each banknote group. The first sensor 601 detects information of an attribute of the banknote P in the banknote group, based on the batch card 116 loaded on the uppermost banknote P out of a plurality of the banknotes P which have been stacked in the banknote group. The information of the attribute of the banknote P is a face value, an issue series, the number of sheets, presence/absence of mixture of note kinds, fitness, and a mixture of fit/unfit notes and so on. The first sensor 601 may be a sensor to optically detect a label given to each banknote group, for example. The first sensor 601 may be a sensor to detect a tag for RF or an IC tag provided in a separator of the banknote group, for example.

The second sensor 603 detects a thickness of the banknote P, a size of the banknote P, material of the banknote P, and security feature of the banknote P and so on. The second sensor 603 is an optical sensor or the like which optically detects the stacked thickness of the whole banknote group relating to the thickness of each banknote P, for example.

The control server 700 judges whether it is possible to perform the processing most effectively, if what of a plurality of the banknote processing apparatuses 800, the banknote group is sorted into, based on the processing status information of a plurality of the banknote processing apparatuses 800, and the information of the banknote group. For example, the control server 700 sets the sorting of the banknote group, so that each of a plurality of the banknote processing apparatuses 800 can continues its operation without interrupting its operation. The control server 700 sets the sorting of the banknote group so that the availability of each of a plurality of the banknote processing apparatuses 800 is leveled. The control server 700 sets the sorting of the banknote group, in accordance with an operation state of a downstream device such as a packing machine. When the downstream device such as a packing machine is stopped, for example, the control server 700 prohibits the sorting of the banknote group.

When the sheet processing system 500 is provided with a device of a special configuration for sample survey or the like, the control server 700 randomly extracts a proper banknote group from a plurality of the banknote groups, and may sort the banknote group into the device of the special configuration.

The control server 700 totally grasps the counting information of the banknotes which have been sorted to a plurality of banknote processing apparatuses 800, as a whole of the sheet processing system 500. Even when the number of the banknotes P to be counted is large, and the banknotes are divided into a plurality of different batches, the control server 700 integrates the counting information. For example, when the banknotes have been sorted by the note kind as a sub-batch in the counting unit, the control server 700 sorts the banknotes for each note kind, and thereby integrates the counting information.

Hereinafter, a flow chart showing an operation example of the sheet processing system 500 of the embodiment will be described.

As shown in FIG. 18, the control server 700 firstly reads processing status information of each of a plurality of banknote processing apparatuses 800, and reads information (processing target information) of each banknote group, based on the detection signals of the first sensor 601 and the second sensor 603 (step S901).

In addition, the execution order of the reading of the processing status information and reading of processing target information is properly set, each time of execution of the processing.

Next, the control server 700 executes sorting processing of each banknote group, based on the processing status information and the processing target information (step S902). And the control server 700 advances the processing to END.

Hereinafter, a flow chart showing an example of the sorting processing of the above-described step S902 will be described.

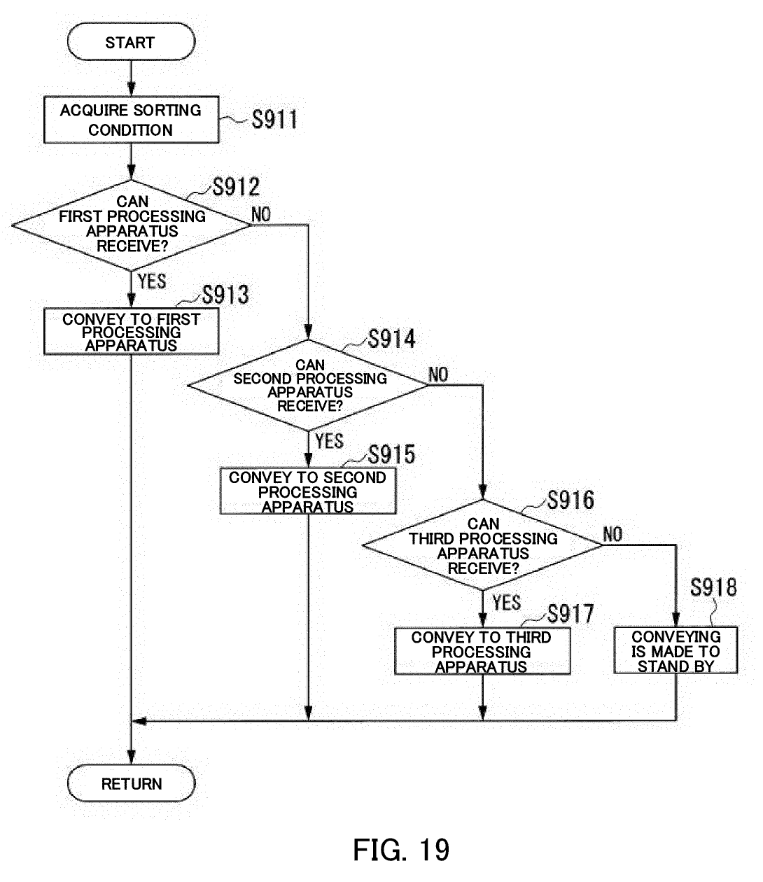

As shown in FIG. 19, the control server 700 firstly acquires the sorting condition from the processing target information (step S911). The sorting condition is information of an attribute of the banknote P and information of a state of the banknote P, and so on.

Next, the control server 700 determines whether or not the first banknote processing apparatus 800 which satisfies the sorting condition of a banknote group can receive the banknote group (step S912).

When this determination result is “NO” (step S912: NO), the control server 700 advances the processing to a step S914.

On the other hand, when this determination result is “YES” (step S912: YES), the control server 700 advances the processing to a step S913.

Next, the control server 700 conveys the banknote group to the first banknote processing apparatus 800 (step S913). And, the control server 700 advances the processing to END.

In addition, the control server 700 determines whether or not the second banknote processing apparatus 800 which satisfies the sorting condition of a banknote group can receive the banknote group (step S914).

When this determination result is “NO” (step S914: NO), the control server 700 advances the processing to a step S916.

On the other hand, when this determination result is “YES” (step S914: YES), the control server 700 advances the processing to a step S915.

Next, the control server 700 conveys the banknote group to the second banknote processing apparatus 800 (step S915). And, the control server 700 advances the processing to END.

Next, the control server 700 determines whether or not the third banknote processing apparatus 800 which satisfies the sorting condition of a banknote group can receive the banknote group (step S916).

When this determination result is “NO” (step S916: NO), the control server 700 advances the processing to a step S918.

On the other hand, when this determination result is “YES” (step S916: YES), the control server 700 advances the processing to a step S917.

Next, the control server 700 conveys the banknote group to the third banknote processing apparatus 800 (step S917). And, the control server 700 advances the processing to END.

In addition, when the banknote processing apparatus 800 which satisfies the sorting condition of a banknote group cannot receive the banknote group, the control server 700 makes the conveying of the banknote group stand by (step S918). And, the control server 700 advances the processing to RETURN.

Hereinafter, a flow chart showing an example of the sorting processing of the above-described step S902 will be described.

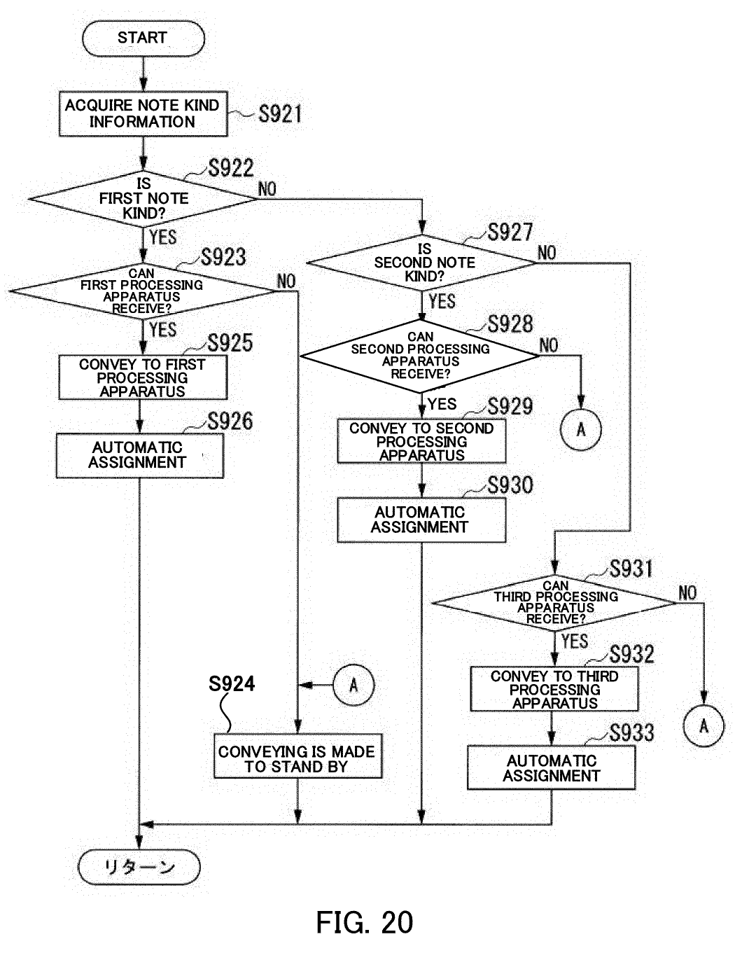

As shown in FIG. 20, the control server 700 firstly acquires the note kind information as the sorting condition from the processing target information (step S921).

Next, the control server 700 determines whether or not the note kind of the banknote group is a first note kind (step S922).

When this determination result is “NO” (step S922: NO), the control server 700 advances the processing to a step S927.

On the other hand, when this determination result is “YES” (step S922: YES), the control server 700 advances the processing to a step S923.

Next, the control server 700 determines whether or not the first banknote processing apparatus 800 can receive the banknote group of the first note kind (step S923).

When this determination result is “NO” (step S923: NO), the control server 700 advances the processing to a step S924.

On the other hand, when this determination result is “YES” (step S923: YES), the control server 700 advances the processing to a step S925.

Next, the control server 700 makes the conveying of the banknote group of the first note kind stand by (step S924). And, the control server 700 advances the processing to END.

In addition, the control server 700 conveys the banknote group of the first note kind to the first banknote processing apparatus 800 (step S925).

Next, the first banknote processing apparatus 800 executes automatic assignment to the banknote group of the first note kind (step S926). And, the control server 700 advances the processing to END.

In addition, the control server 700 determines whether or not the note kind of the banknote group is a second note kind (step S927).

When this determination result is “NO” (step S927: NO), the control server 700 advances the processing to a step S931.

On the other hand, when this determination result is “YES” (step S927: YES), the control server 700 advances the processing to a step S928.

Next, the control server 700 determines whether or not the second banknote processing apparatus 800 can receive the banknote group of the second note kind (step S928).

When this determination result is “NO” (step S928: NO), the control server 700 advances the processing to the above-described step S924.

On the other hand, when this determination result is “YES” (step S928: YES), the control server 700 advances the processing to a step S929.

Next, the control server 700 conveys the banknote group of the second note kind to the second banknote processing apparatus 800 (step S929).

Next, the second banknote processing apparatus 800 executes automatic assignment to the banknote group of the second note kind (step S930). And, the control server 700 advances the processing to END.

Next, the control server 700 determines whether or not the third banknote processing apparatus 800 can receive the banknote group of a third note kind (step S931).

When this determination result is “NO” (step S931: NO), the control server 700 advances the processing to the above-described step S924.

On the other hand, when this determination result is “YES” (step S931: YES), the control server 700 advances the processing to a step S932.

Next, the control server 700 conveys the banknote group of the third note kind to the third banknote processing apparatus 800 (step S932).

Next, the second banknote processing apparatus 800 executes automatic assignment to the banknote group of the third note kind (step S933). And, the control server 700 advances the processing to END.

Hereinafter, a flow chart showing an example of the sorting processing of the above-described step S902 will be described.

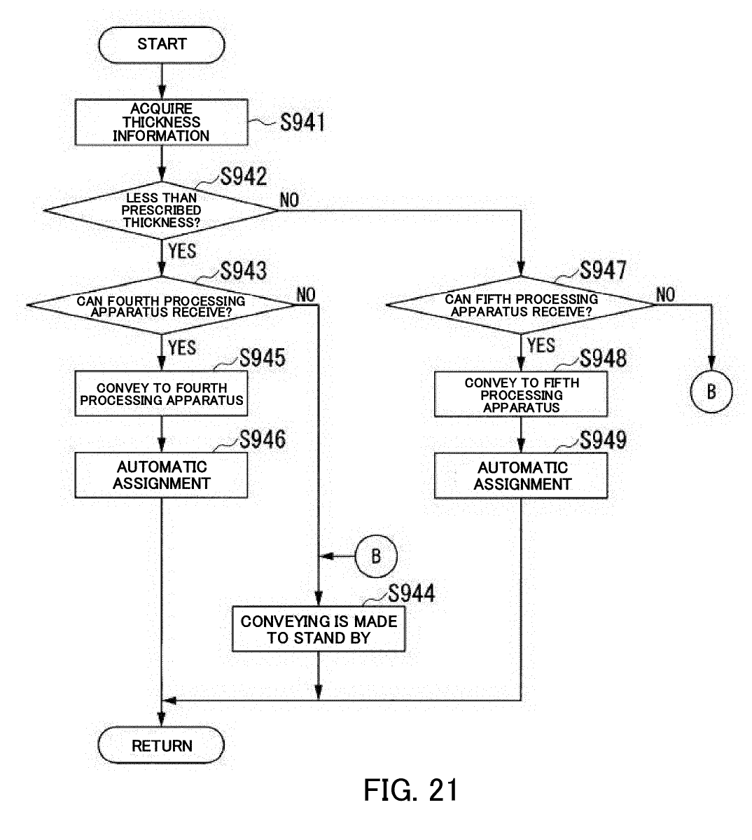

As shown in FIG. 21, the control server 700 firstly acquires the thickness information as the sorting condition from the processing target information (step S941).

Next, the control server 700 determines whether or not a thickness of the banknote P per sheet is less than a prescribed thickness (step S942).

When this determination result is “NO” (step S942: NO), the control server 700 advances the processing to a step S947.

On the other hand, when this determination result is “YES” (step S942: YES), the control server 700 advances the processing to a step S943.

Next, the control server 700 determines whether or not the fourth banknote processing apparatus 800 which performs a relatively high speed processing to the banknote P can receive the banknote group (step S943).

When this determination result is “NO” (step S943: NO), the control server 700 advances the processing to a step S944.

On the other hand, when this determination result is “YES” (step S943: YES), the control server 700 advances the processing to a step S945.

Next, the control server 700 makes the conveying of the banknote group stand by (step S944). And, the control server 700 advances the processing to END.

In addition, the control server 700 conveys the banknote group to the fourth banknote processing apparatus 800 (step S945).

Next, the fourth banknote processing apparatus 800 executes automatic assignment to the banknote group (step S946). And, the control server 700 advances the processing to END.

In addition, the control server 700 determines whether or not the fifth banknote processing apparatus 800 which performs a relatively low speed processing to the banknote P can receive the banknote group (step S947).

When this determination result is “NO” (step S947: NO), the control server 700 advances the processing to the above-described step S944.

On the other hand, when this determination result is “YES” (step S947: YES), the control server 700 advances the processing to a step S948.

Next, the control server 700 conveys the banknote group to the fifth banknote processing apparatus 800 (step S948).

Next, the fifth banknote processing apparatus 800 executes automatic assignment to the banknote group (step S949). And, the control server 700 advances the processing to END.

Hereinafter, a flow chart showing an example of the sorting processing of the above-described step S902 will be described.

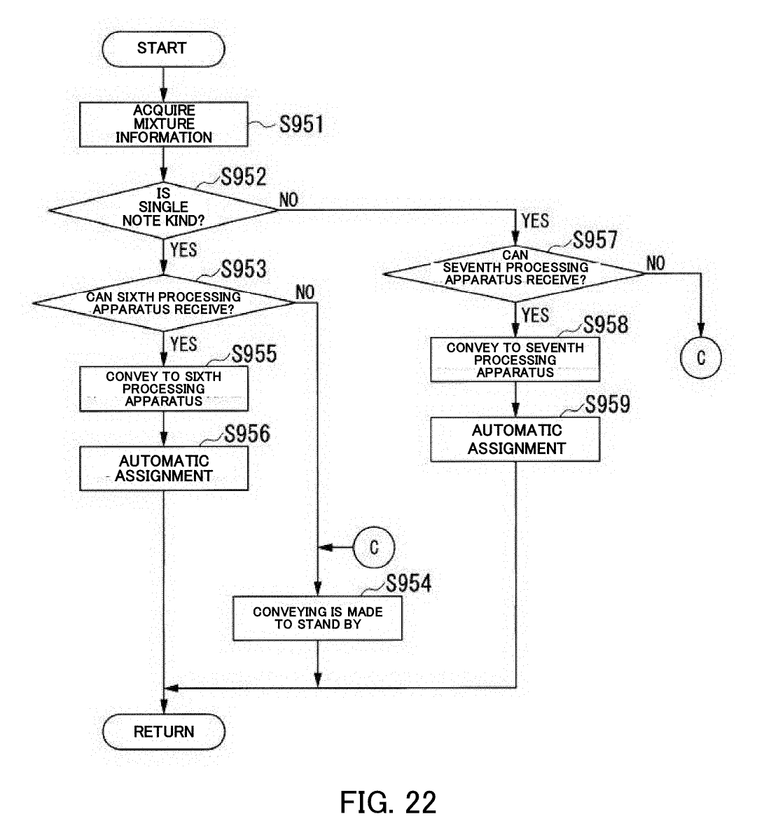

As shown in FIG. 22, the control server 700 firstly acquires mixture information as the sorting condition from the processing target information (step S951). The mixture information is information indicating whether the banknote group is composed of banknotes of a single note kind, or the banknote group is composed of the mixture of banknotes of a plurality of note kinds.

Next, the control server 700 determines whether or not the banknote group is of a single note kind (step S952).

When this determination result is “NO” (step S952: NO), the control server 700 advances the processing to a step S957.

On the other hand, when this determination result is “YES” (step S952: YES), the control server 700 advances the processing to a step S953.

Next, the control server 700 determines whether or not the sixth banknote processing apparatus 800 which can deal with a banknote group of a single note kind can receive the banknote group (step S953).

When this determination result is “NO” (step S953: NO), the control server 700 advances the processing to a step S954.

On the other hand, when this determination result is “YES” (step S953: YES), the control server 700 advances the processing to a step S955.

Next, the control server 700 makes the conveying of the banknote group of a single not kind stand by (step S954). And, the control server 700 advances the processing to END.

In addition, the control server 700 conveys the banknote group of a single note kind to the sixth banknote processing apparatus 800 (step S955).

Next, the sixth banknote processing apparatus 800 executes automatic assignment to the banknote group of a single note kind (step S956). And, the control server 700 advances the processing to END.

In addition, the control server 700 determines whether or not the seventh banknote processing apparatus 800 which can deal with a banknote group of mixed note kinds can receive the banknote group (step S957).

When this determination result is “NO” (step S957: NO), the control server 700 advances the processing to the above-described step S954.

On the other hand, when this determination result is “YES” (step S957: YES), the control server 700 advances the processing to a step S958.

Next, the control server 700 conveys the banknote group of mixed note kinds to the seventh banknote processing apparatus 800 (step S958).

Next, the sixth banknote processing apparatus 800 executes automatic assignment to the banknote group of mixed note kinds (step S959). And, the control server 700 advances the processing to END.

According to the above-described embodiment, the controller 703 which controls the sorting of banknote group into a plurality of the sheet processing apparatuses 800, based on the information of a banknote group and the processing status information is provided, and thereby it is possible to properly perform sorting processing of the banknote group, while making each of the banknote processing apparatuses 800 effectively operate.

Since the automatic sorting apparatus 600 is provided which makes the sorting of a banknote bundle stand by when the banknote processing apparatus 800 which can process a banknote group does not exist, the sorting of the banknote group is adjusted while continuing the operation of each of the banknote processing apparatus 800, and thereby it is possible to improve the operation efficiency of the whole system.

Since a plurality of the banknote processing apparatuses 800 which perform automatic assignment processing are provided, it is possible to omit labor required for operation of the whole system, by the combination with the automatic sorting operation of the banknote group by the automatic sorting apparatus 600. Even when the number of a plurality of the banknote processing apparatuses 800 increases, it is possible to operate the whole system easily and effectively.

Since the first sensor 601 to detect the information given to a banknote group and a second sensor 603 to detect the state of a banknote group, it is possible to perform various sorting processings.

Hereinafter, modifications will be described.

Hereinafter, banknote processing apparatuses according to modifications of the embodiment will be described.

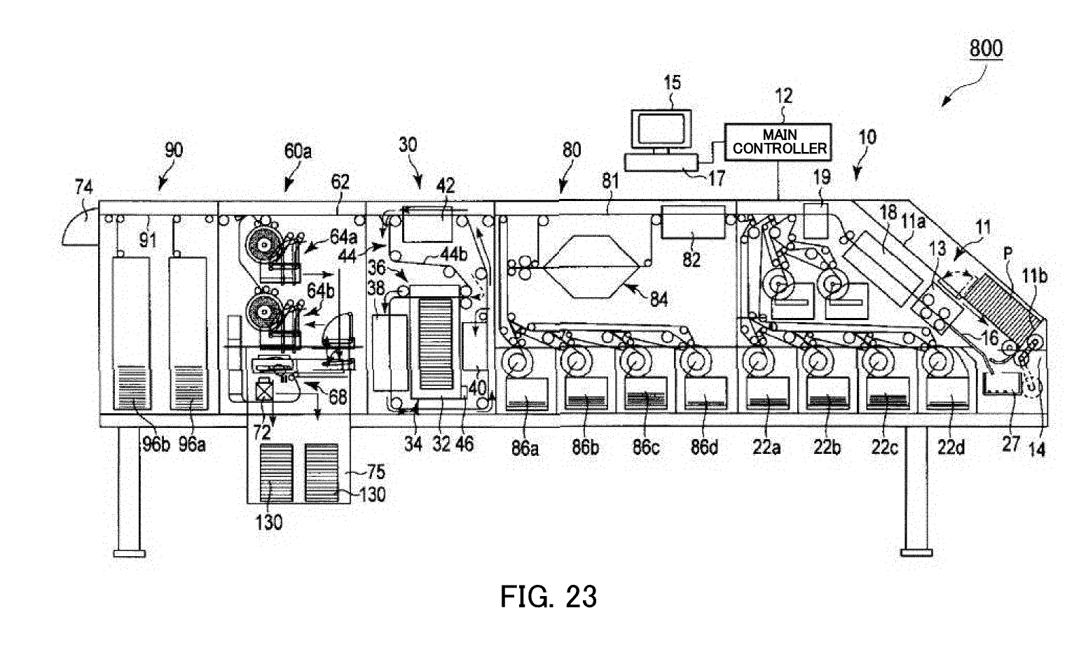

FIG. 23 shows a banknote processing apparatus according to a first modification of the embodiment. As shown in this figure, the banknote processing apparatus is provided with the main module 10, an alignment module 80, the loading module 30, one sealing module 60a, and a large capacity stacking module 90, and these modules are arranged side by side in a line by this order, and are electrically and mechanically coupled with each other. In the main module 10, the main controller 12 which controls an operation of this main module and the whole apparatus is provided.

The main module 10, the loading module 30, the sealing module 60a are configured in the same way as the embodiment. The alignment module 80 which is provided between the main module 10 and the loading module 30 is provided with a conveying path 81 which conveys a banknote P sent from the main module 10, an alignment mechanism 82 which is provided at an upstream side of the conveying path 81, a reversing device 84 which is provided along the conveying path 81 at a downstream side of the alignment mechanism 82, and a plurality of stackers 86a, 86b, 86c, 86c which are arranged side by side along the conveying path 81.

The alignment mechanism 82 is configured in the same way as the alignment mechanism 42 of the loading module 30, and aligns the center of the banknote to be sent through the conveying path 81 with the center of the conveying path, and corrects the skewed banknote so that a side thereof is directed in the direction orthogonal to the conveying direction. The reversing device 84 reverses the direction of the banknote P to be sent through the conveying path 81, and thereby aligns the front, back direction, or the forward, backward direction with a designated direction, and sends out the banknote.

That is, the banknote P is taken in in any posture of the four kinds of face front (FF: Face Front), face rear (FR: Face Rear), buck front (BF: Buck Front), and buck rear (BR: Buck Rear). The reversing device 84 can align the direction of the banknote P to be sent through the conveying path 81 with any of FF, FR, BF, and BR.

In addition, FF indicates a posture in which the surface of the banknote P faces upward, and the upper end of the banknote P is the front in the conveying direction. FR indicates a posture in which the surface of the banknote P faces upward, and the upper end of the banknote P is the rear in the conveying direction. BF indicates a posture in which the back surface of the banknote P faces upward, and the upper end of the banknote P is the front in the conveying direction. BR indicates a posture in which the back surface of the banknote P faces upward, and the upper end of the banknote P is the rear in the conveying direction.

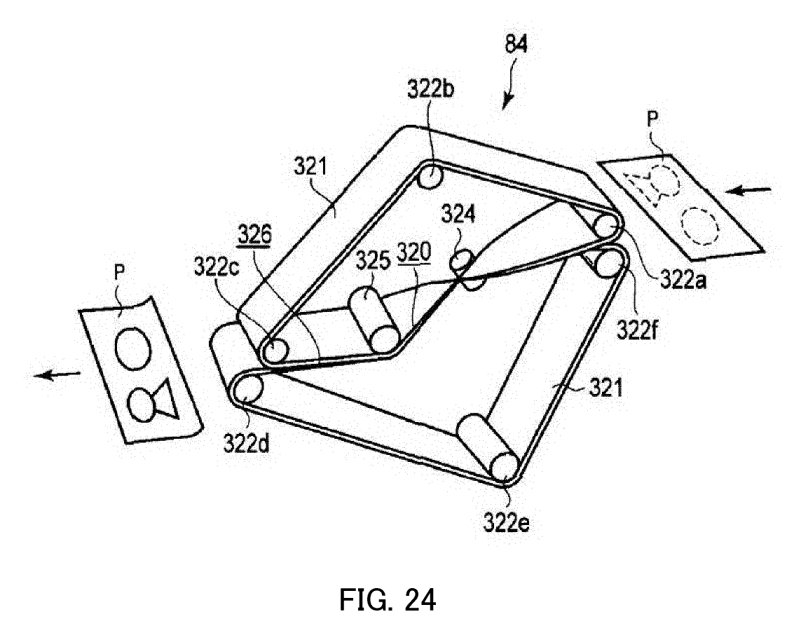

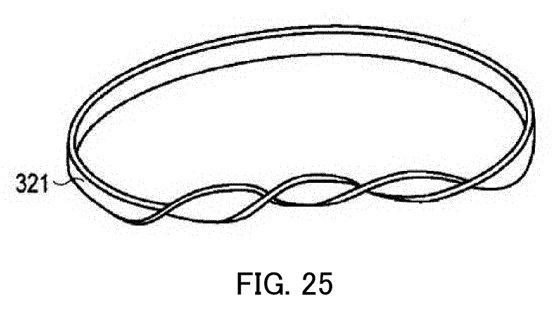

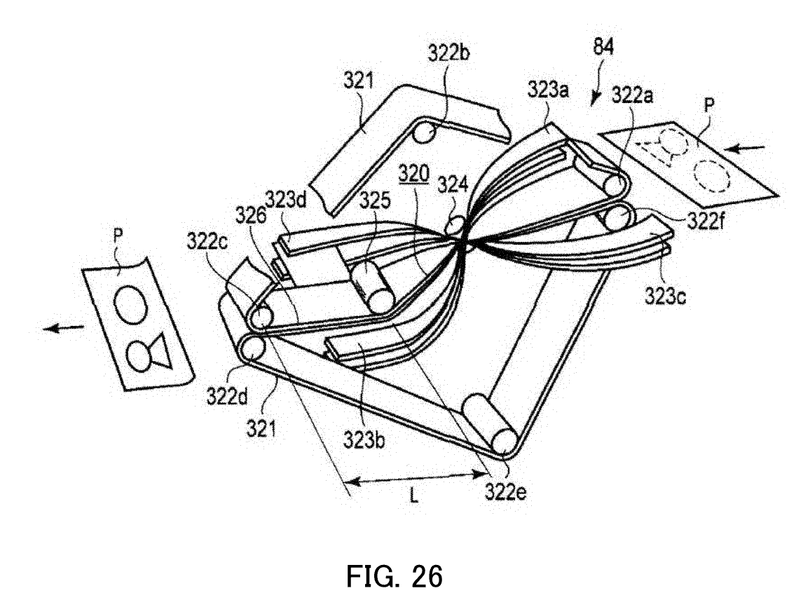

As shown in FIG. 24, the reversing device 84 is provided with a twisted conveying path 320 which is twisted by 180 degrees, and this twisted conveying path 320 is formed as shown in FIG. 25 such that two extendable endless belts (hereinafter, called twisted belts) 321 each of which is formed by being twisted by 720 degrees, are wound around a plurality of rollers 322a-322f in the shape of a FIG. 8, and the twisted portions of the twisted belts 321 are overlapped with each other. Further, as shown in FIG. 26, flat plate-like twisted guide bodies 323a, 323b, 323c, 323d are arranged in the state along the both sides of the twisted conveying path 320. These flat plate-like twisted guide bodies are supported by supports not shown, and the guide bodies 323a, 323b, and the guide bodies 323c, 323d form pairs respectively, and each pair is twisted in accordance with the twist of the twisted belt 321 while keeping an interval shown in the figure. These twisted guides 323a-323d are located at the both sides of the twisted belts 321, and are provided continuously from the entrance to exit of the twisted conveying path 320.

The reversing device 84 is provided with an idler roller 324 which is provided at the center portions of the twisted belts 321, and this idler roller gives a holding force to the banknote P. A roller 325 for forming a horizontal conveying path 326 is provided at a downstream side of the twisted conveying path 320.

The banknote P which has been sent from the alignment mechanism 82 to the reversing device 84 passes through the twisted conveying path 320, and thereby the front and rear thereof is reversed, and further the banknote P passes through the horizontal conveying path 326, and thereby the peculiarity due to twist is corrected, and then the banknote P is discharged to the downstream side. At this time, since the banknote P is guided at the both end portions in the long direction between the guide bodies 323a, 323b, and between the guide bodies 323c, 323d, even when the banknote P which is folded in four, or two, or weak in stiffness is reversed at high speed, the banknote P is backed up at the both ends thereof by the twisted guides, and thereby it is possible to prevent the fold caused by an air pressure or the generation of a skew.

In addition, the reversing device 84 has a mechanism to exchange the upper end and the lower end by a switch back system. In this case, the reversing device 84 conveys the banknote P which has been conveyed in the FR posture or the BR posture to a prescribed position on the conveying path, and introduces the banknote P again in the conveying path so that the upper end of the banknote P is the front in the conveying direction. With the configuration like this, the reversing device 84 can align the direction of the banknotes P to be sent through the conveying path 81 with any of FF, FR, BF, and BR.

As shown in FIG. 23, the banknotes P which have been sent out with the directions thereof being aligned are sent to the loading module 30 through the conveying path 81, or are sent and stacked in any of the stackers 86a-86d. In addition, the banknotes which have been sent out from the loading module 30 with the directions thereof being aligned are returned to the main module 10, and may be stacked in the stackers 22a to 22d.

Regarding the banknote loading processing to the loading storage 32, the banknotes P which have been sent out with the directions thereof being aligned are set to the loading module 30 through the conveying path 81, and are loaded in the loading storage 32. At this time, the banknotes are sent out while the directions thereof are positively reversed to front and back alternately, and the banknotes may be stacked in the loading storage 32 so that the direction thereof becomes front and back, alternately. In this case, the banknotes are hardly affected by the friction and intaglio between the stacked banknotes, and thereby it is possible to easily take out the banknote from the loading storage 32.

In addition the stackers 86a to 86d of the alignment module 80 can be used as stackers each to stack the banknotes taken out from the loading storage 32 for each denomination, or can be used as a reject storage or an unfit note storage which stacks the reject notes or the unfit notes taken out from the loading storage 32.

The large capacity stacking module 90 is connected to the downstream side of the sealing module 60a. This large capacity stacking module 90 is provided with a conveying path 91 which conveys the banknotes P sent from the sealing module 60a, and large capacity stackers 92a, 92b each of which can stack a definite amount of the banknotes sent through the conveying path 91. In the case of manually loading a definite amount of the banknotes in the loading storage 32, the banknotes which have been sent from the main module 10 or the loading storage 32 are stacked in each of the stackers 92a, 92b by a predetermined definite amount. And the stacked banknotes are taken out collectively from the large amount stackers 92a, 92b, and manually loaded in the loading storage 32. By this means, it is possible to easily load a predetermined definite amount of banknotes in the loading storage 32.

According to the banknote processing apparatus with the above-described configuration, it is possible to perform various processings such as the recovery, loading of banknotes to the loading storage 32, in the same manner as the above-described embodiment. In addition, the alignment module 80 is provided, and thereby, the banknotes can be stacked, loaded or sealed in the state that the direction of the banknotes is optionally set.

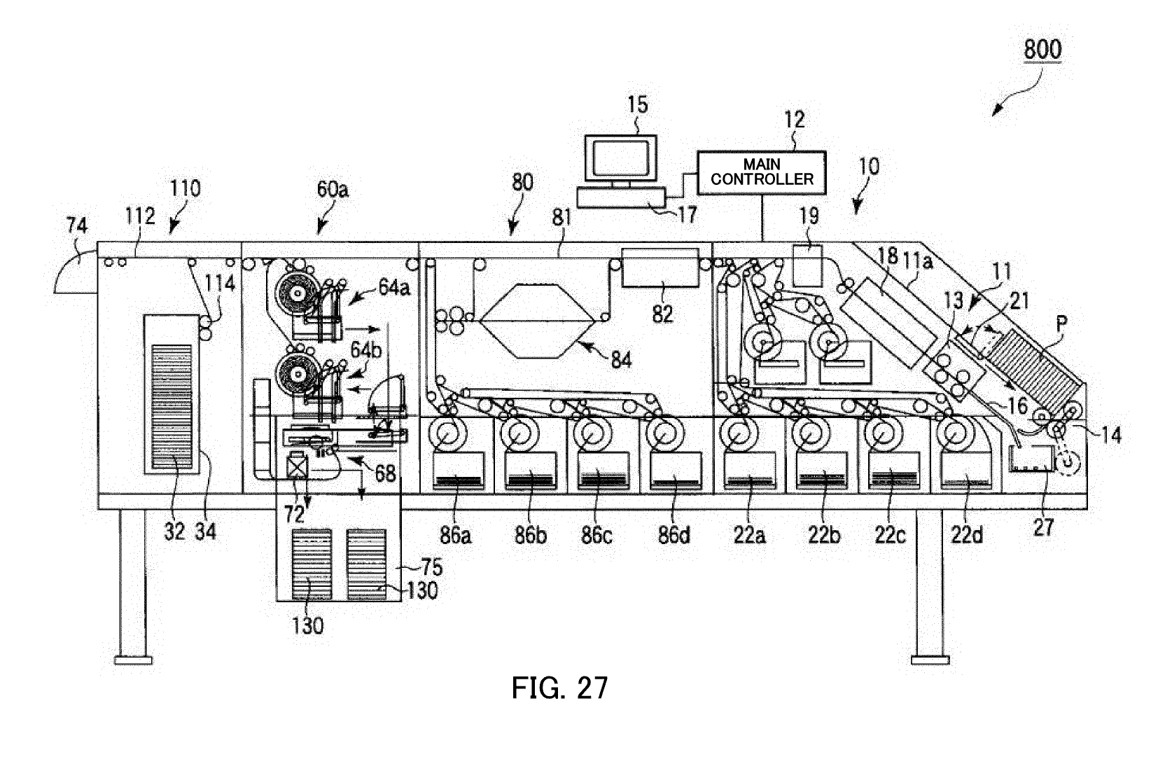

FIG. 27 shows a banknote processing apparatus according to a second modification of the embodiment. According to the second modification of the embodiment, the banknote processing apparatus is provided with the main module 10, the alignment module 80, one sealing module 60a, and a loading module 110, and these modules are arranged side by side in a line by this order, and are electrically and mechanically coupled with each other. In the main module 10, the main controller 12 which controls an operation of this main module and the whole apparatus is provided.

The main module 10, the alignment module 80, the sealing module 60a are configured in the same way as the embodiment and the first modification of the embodiment. The loading module 110 connected to the downstream side of the sealing module 60a is provided with the loading portion 34 in which a loading storage exclusive for money reception of an ATM or a loading storage capable of receiving and paying money is to be detachably loaded, a conveying path 112 to convey the banknote sent from the sealing module 60a side, a take-in mechanism 114 which loads the sent banknote from the conveying path 112 to the loading storage 32. The banknote P which is fed to the main module 10 is sent to the loading module 110 through the main module 10, the alignment module 80, the sealing module 60a, and is loaded in the loading storage 32.

According to the banknote processing apparatus with the above-described configuration, after the banknote P is inspected by the inspection device 18 of the main module 10, it is possible to stack, seal the banknote P, or load the banknote P in the loading storage 32 exclusive for money reception. In addition, it is possible to replenish, load a banknote to the loading storage 32 exclusive for money reception. Besides, also in the second modification, it is possible to obtain the same operation and effect as the embodiment and the first modification.

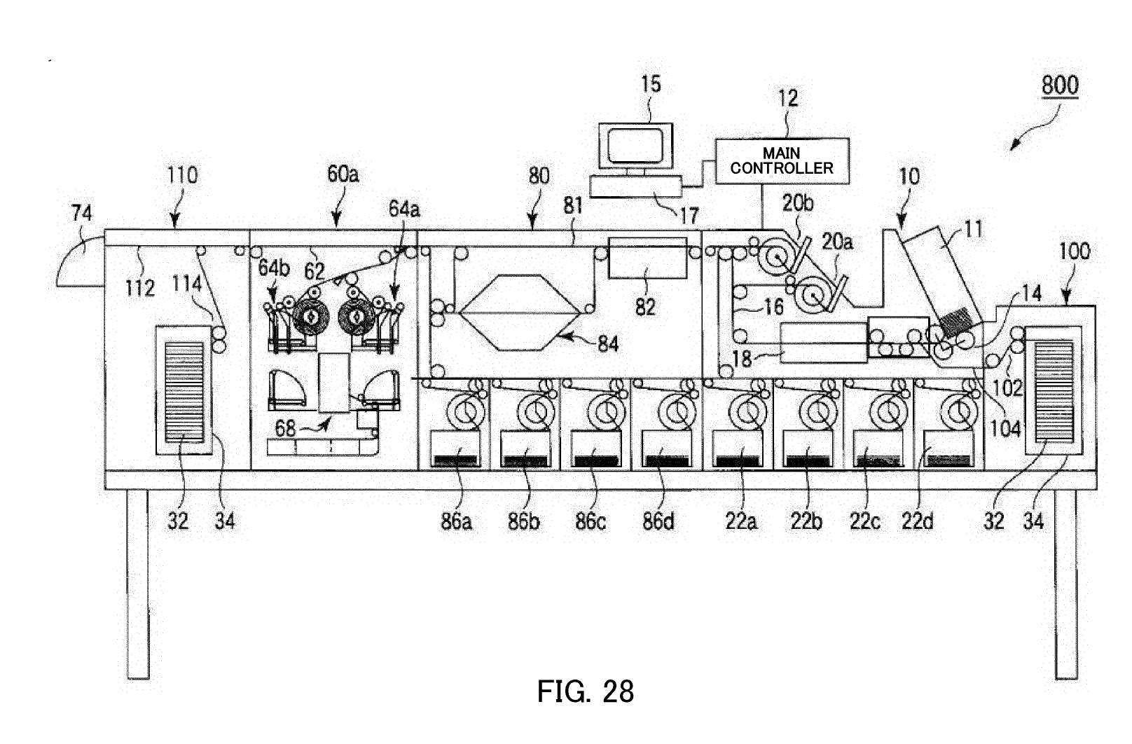

FIG. 28 shows a banknote processing apparatus according to a third modification of the embodiment. According to the third modification of the embodiment, the banknote processing apparatus is provided with a takeout module 100, the main module 10, the alignment module 80, one sealing module 60a, and the loading module 110, and these modules are arranged side by side in a line by this order, and are electrically and mechanically coupled with each other. In the main module 10, the main controller 12 which controls an operation of this main module and the whole apparatus is provided.

The main module 10, the alignment module 80, the sealing module 60a, the loading module 110 are configured in the same way as the embodiment, and the first modification and the second modification. The takeout module 100 which is provided at the upstream side of the main module 10 is provided with the loading portion 34 in which a loading storage exclusive for money payment of an ATM or a loading storage capable of receiving and paying money is to be detachably loaded, a takeout mechanism 102 which takes out a banknote from the loading storage 32, a conveying path which conveys the taken-out banknote. The conveying path of the takeout module 100 is communicated with the conveying path 104 provided at the takeout mechanism 14 side of the main module 10. The banknote which has been taken out from the loading storage 32 is sent to the inspection device 18 through the conveying path 104 of the main module 10, and after the inspection, the fit note and the unfit note are stacked in the stackers 22a-22d, or sent to the sealing module 60a or the loading module 110, through the alignment module.

The loading module 110 connected to the downstream side of the sealing module 60a is provided with the loading portion 34 in which a loading storage exclusive for money reception of an ATM or a loading storage capable of receiving and paying money is to be detachably loaded, the conveying path 112 to convey the banknote sent from the sealing module 60a side, the take-in mechanism 114 which loads the sent banknote from the conveying path 112 to the loading storage 32. The banknote P which is fed to the main module 10, or the banknote which has been taken out from the loading storage 32 by the takeout module 100 is sent to the loading module 110 through the main module 10, the alignment module 80, the sealing module 60a, and is loaded in the loading storage 32.

According to the banknote processing apparatus with the above-described configuration, after a banknote is taken out form the loading storage 32 exclusive for money payment, and the banknote is inspected by the inspection device 18 of the main module 10, it is possible to stack, seal the banknote P, or load the banknote P in the loading storage 32 exclusive for money reception. In addition, it is possible to replenish, load a banknote to a loading storage exclusive for money reception.

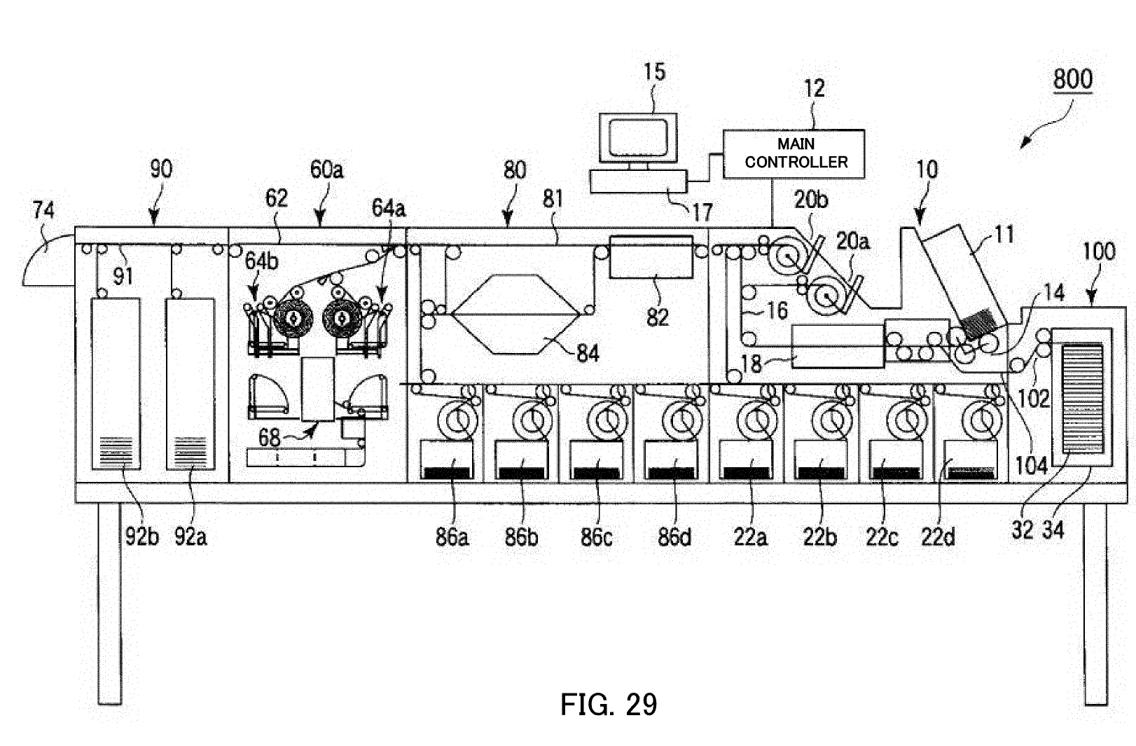

FIG. 29 shows a banknote processing apparatus according to a fourth modification of the embodiment. According to the fourth modification of the embodiment, the banknote processing apparatus is provided with the takeout module 100, the main module 10, the alignment module 80, one sealing module 60a, and the large capacity stacking module 90, and these modules are arranged side by side in a line by this order, and are electrically and mechanically coupled with each other. In the main module 10, the main controller 12 which controls an operation of this main module and the whole apparatus is provided.

The takeout module 100, the main module 10, the alignment module 80, the sealing module 60a are configured in the same way as the third modification. The large capacity staking module 90 is configured in the same way as the first modification of the embodiment.

According to the banknote processing apparatus with the above-described configuration, the banknote which has been taken out from the loading storage 32 by the takeout module 100 is sent to the inspection device 18 through the conveying path 104 of the main module 10, and after the inspection, the fit note and the unfit note are stacked in the stackers 22a-22d, or sent to the sealing module 60a or the large capacity stacking module 90, through the alignment module 80.

In the case of manually loading a definite amount of the banknotes in the loading storage 32, the banknotes which have been sent from the main module 10 or the banknotes which have been taken out from the loading storage 32 are stacked in each of the stackers 92a, 92b by a predetermined definite amount. And the stacked banknotes are taken out collectively from the large amount stackers 92a, 92b, and are manually loaded in the loading storage 32. By this means, it is possible to easily load a predetermined definite amount of banknotes in the loading storage 32.

In the above-described embodiment, a plurality of the modules of the banknote processing apparatus are configured to be arranged side by side in a line, but without being limited to this, a plurality of the modules may be arranged side by side in an L shape or a U shape.

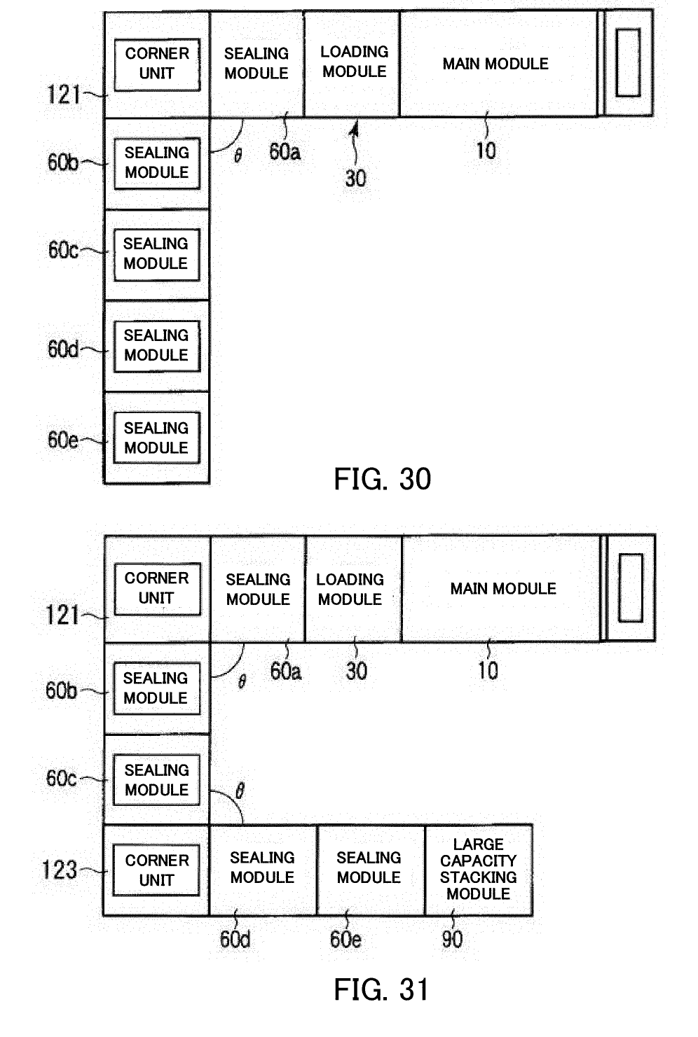

As shown in FIG. 30, the main module 10, the loading module 30, the sealing module 60a are arranged side by side, and further, the four sealing modules 60b, 60c, 60d, 60e are arranged side by side in a line across a corner unit 121, and in the direction approximately orthogonal to the line of the main module 10, the loading module 30, the sealing module 60a side by side. By this means, a plurality of the modules are arranged side by side in an L shape. The configuration of each module is the same as the above-described embodiment and the first modification to the fourth modification. The corner unit 121 is provided with a conveying path to convey a banknote, and a rotation mechanism which rotates a banknote from an approximately horizontal state to a vertical state, and thereby enables the movement of the corner portion thereof. An inner angle of the corner portion of the module arrangement is set to about 45-135 degrees, for example.

As shown in FIG. 31, the main module 10, the loading module 30, the sealing module 60a are arranged side by side in a line, and further, the two sealing modules 60b, 60c are arranged side by side in a line across the corner unit 121, and in the direction approximately orthogonal to the line of the main module 10, the loading module 30, the sealing module 60a side by side. Further, the two sealing modules 60d, 60e and the large capacity stacking module 90 are arranged side by side in a line across a corner unit 123, and in the direction approximately orthogonal to the line of the sealing module 60b, 60c side by side. By this means, a plurality of the modules are arranged side by side in a U shape. The configuration of each module is the same as the above-described embodiment and the first modification to the fourth modification. Each of the corner units 121, 123 is provided with a conveying path to convey a banknote, and a rotation mechanism which rotates a banknote from an approximately horizontal state to a vertical state, and thereby enables the movement of the corner portion thereof. Inner angles of the two corner portions of the module arrangement are respectively set to about 45-135 degrees, for example.

As described above, even in the case that the banknote processing apparatus is provided with many modules, a plurality of the modules are arranged side by side in an L-shaped state or a U-shaped state, and thereby it is possible to arrange a plurality of the module in a comparatively near place, and it is possible to improve operability.

In addition, in the above-described embodiment, the number of the modules to be connected is not limited to that of the embodiment, but can be increased or decreased if necessary, and the kind of the modules can be variously selected.

For example, the sheet to be processed is not limited to a banknote, a batch card, but the embodiment may be applied to other sheets such as a casino card, securities and so on.

It has been described that the sheet processing system 500 of the above-described embodiment is provided with a plurality of the same sheet processing apparatuses 800, but it is not limited to this.

In the modification of the embodiment, the sheet processing system 500 may be provided with a plurality of different sheet processing apparatuses 800. The control server 700 may sort and convey sheet groups to a plurality of the different sheet processing apparatuses 800 in parallel, respectively, or may sort and convey sheet groups in accordance with a prescribed processing priority order. For example, to begin with, the control server 700 preferentially sorts and conveys sheet groups to a relatively large-sized and high-speed sheet processing apparatus 800. Next, the control server 700 sorts and conveys the sheet groups which have been sorted and stacked in the relatively large-sized and high-speed sheet processing apparatus 800, to relatively small-sized and high-precision sheet processing apparatuses 800. The relatively small-sized and high-precision sheet processing apparatus 800 can improve precision of sorting stacking of sheet groups, compared with the relatively large-sized and high-speed sheet processing apparatus 800. For example, the control server sorts and conveys the reject notes which have been rejected by the relatively large-sized and high-speed sheet processing apparatus 800, to the relatively small-sized and high-precision sheet processing apparatuses 800.

Hereinafter, the relatively large-sized and high-speed sheet processing apparatus 800 compared with the sheet processing apparatus 800 of the embodiment will be described with reference to the drawings. In the following, the sheet processing apparatus 800 according to a seventh modification of the embodiment is provided with a sheet preprocessing apparatus L5 and a main body processing apparatus L100.

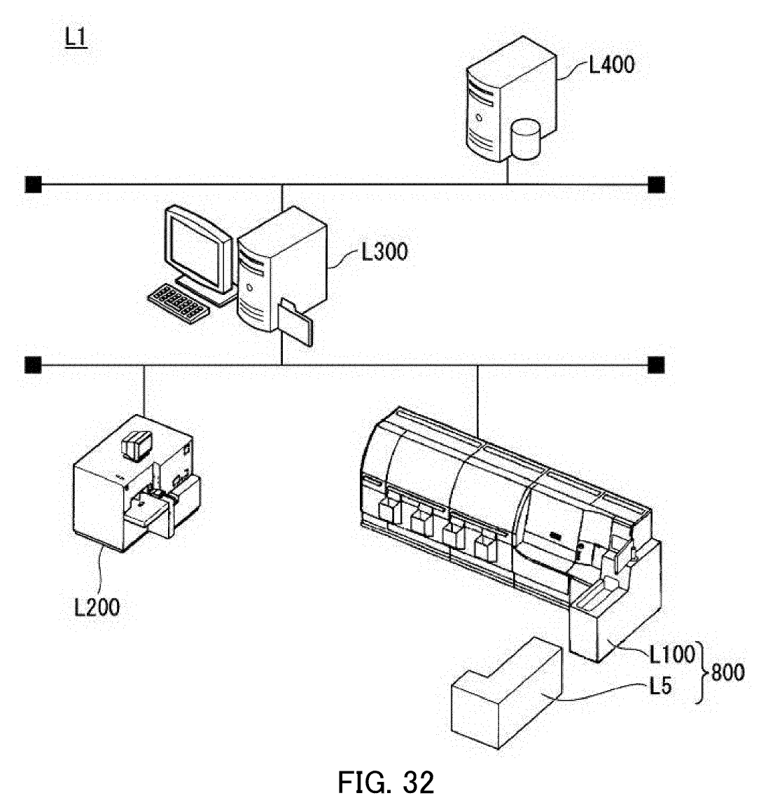

To begin with, a sheet collation system L1 according to the seventh modification of the embodiment will be described. FIG. 32 is a configuration diagram of the sheet collation system L1 according to the seventh modification of the embodiment. The sheet collation system L1 is provided with the main body processing apparatuses L100 of at least one or more sheet processing apparatuses, a perusal apparatus L200, a sheet collation apparatus L300, a host server L400. The sheet processing apparatus 800 is provided with the sheet preprocessing apparatus L5 described later, and the main body processing apparatus L100. The main body processing apparatus L100, the perusal apparatus L200, and the sheet collation apparatus L300 are connected by a network, such as a LAN (Local Area Network).

The perusal apparatus L200 re-inspects a note (an excluded note) which has been excluded once by the main body processing apparatus 100 at a lower speed and more precisely than the min body processing apparatus L100. The perusal apparatus L200 correlates the counting result of the sheets P, a note kind of the sheet P, a sheet number of the sheet P, a batch card number, and the determination result and so on, to each bundle of the sheets P that are excluded notes. The perusal apparatus L200 transmits the correlated re-inspection result (including the batch card number, the note kind of the sheet P, the number of the sheets, and the determination result) to the sheet collation apparatus L300.

The sheet collation apparatus L300 gives an index to the inspection result and the sheet number which have been transmitted from the main body processing apparatus 100, and stores them in a storage medium within the sheet collation apparatus L300. The sheet P in which the main body processing apparatus L100 has determined that its effectiveness cannot be discriminated is discharged as an excluded note. Regarding the excluded note, an image for each item, the inspection result of each inspection item, all digits (characters) which can be read in the sheet number are transmitted from the main body processing apparatus L100 to the sheet collation apparatus L300. The sheet collation apparatus L300 gives an index to the information which has been transmitted from the main body processing apparatus 100, and stores it in the storage medium within the sheet collation apparatus L300. In addition, an operator inputs the excluded note which has been discharged from the main body processing apparatus L100 into the perusal apparatus L200. The perusal apparatus L200 re-inspects the inputted excluded note. In this case, the perusal apparatus L200 processes a bundle of the sheets P and a batch card BC, in the same manner as the main body processing apparatus L100.

The sheet collation apparatus L300 combines the re-inspection result transmitted from the perusal apparatus L200 and the inspection result transmitted from the main body processing apparatus L100, and stores the combined inspection results in the storage medium within the sheet collation apparatus L300. For example, the sheet collation apparatus L300 adds the re-inspection result to the inspection result including identification information which coincides with the identification information included in the re-inspection result. When the perusal of a money reception batch is finished, the sheet collation apparatus L300 collates the money reception data with the counting data of the sheets P which have been inspected and perused.

The host server L400 manages and stores the information which the sheet collation apparatus L300 has acquired from the main body processing apparatus L100, or the perusal apparatus L200. In addition, the host server L400 manages the result which the sheet collation apparatus L300 has processed.

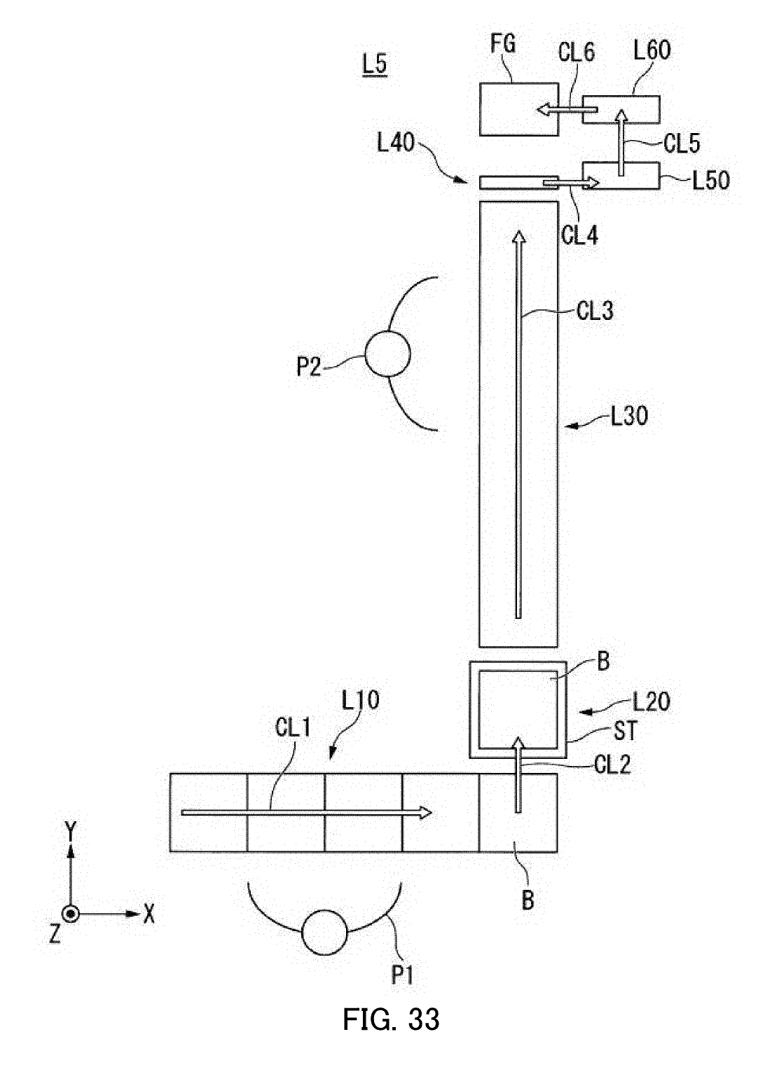

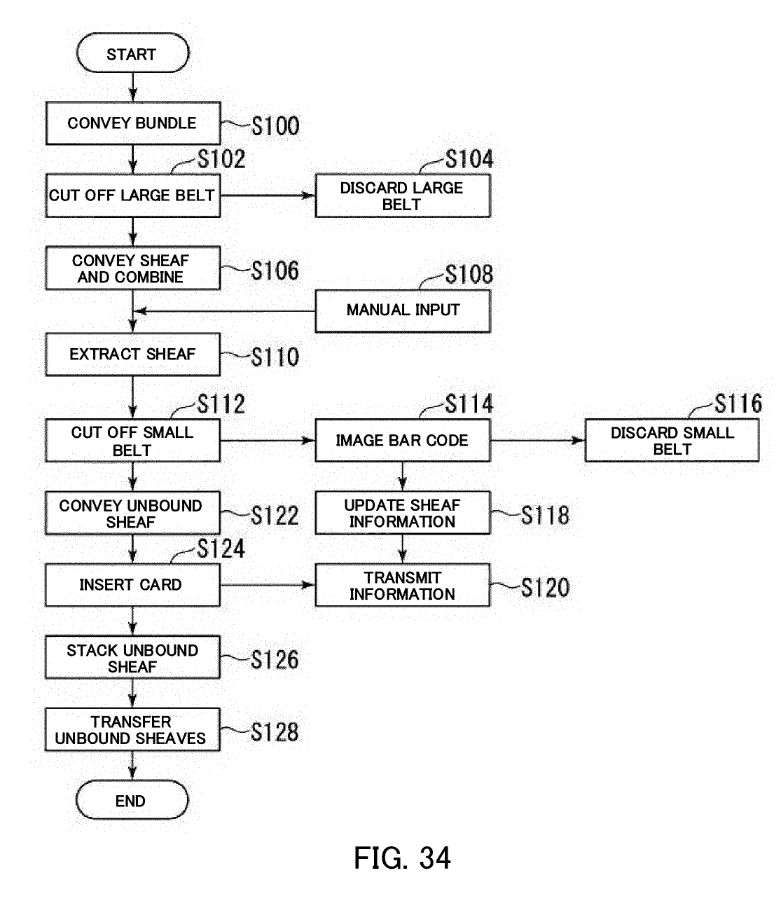

FIG. 33 is a schematic diagram showing an outline configuration of the sheet preprocessing apparatus L5 according to the seventh modification of the embodiment. FIG. 34 is a flow chart showing an operation of the sheet preprocessing apparatus L5 according to the seventh modification of the embodiment.

The sheet preprocessing apparatus L5 functions as a preprocessing apparatus which performs preprocessing of transferring the sheet P to the main body processing apparatus L100. The sheet preprocessing apparatus L5 is provided with a bundle input portion L10, a large belt removing portion L20, a sheaf combining portion L30, a sheaf extracting portion L40, a small belt removing portion L50, and a sheaf stacking portion L60.

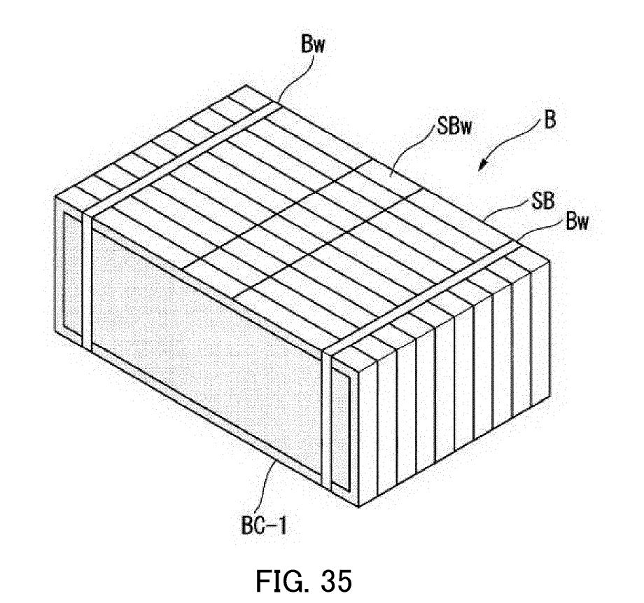

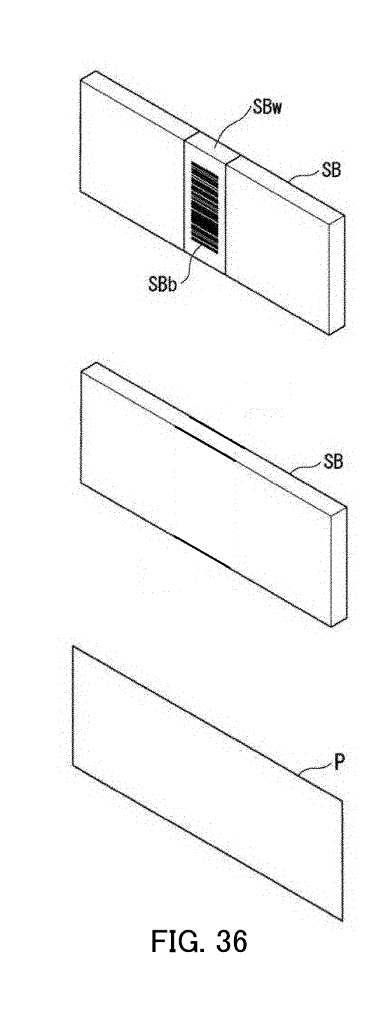

The bundle input portion L10 conveys a bundle formed by sealing a prescribed number of sheaves with a large belt, in which each sheaf is formed by sealing a plurality of sheets P with a small belt (step S100). FIG. 35 is a perspective view of a bundle B in the seventh modification of the embodiment. FIG. 36 is a perspective view of a sheaf SB and a sheet P in the seventh modification of the embodiment. The sheaf SB is a bundle which is formed by sealing a plurality of sheets P with a small belt SBw. The small belt SBw is wound around the sheet P in the short side direction. The small belt SBw is a binding material such as a paper belt. A bar code SBb is pasted on the small belt SBw. The information embedded in the bar code SBb is sheaf information which is common in a plurality of sheets P that are bound in the sheaf SB. The sheaf information is information for each sheaf SB, for identifying the sheaf SB, such as a strap number, a bank name, a branch name, a handler, or a time and date of handling. In the seventh modification of the embodiment, the example in which the bar code SBb is pasted on the small belt SBw has been described, but the sheaf information may be printed on the small belt SBw in the form of characters.

The bundle B is formed such that the ten sheaves SB are stacked in the short side direction and are sealed with a large belt Bw. In the bundle B shown in FIG. 35, a primary batch card BC-1 for identifying the bundle B is sealed along with a prescribed number of the sheaves SB. The large belts Bw are wound around the sheaves SB at two positions in the thickness direction and the short side direction thereof. The large belt Bw is an extendable binding material such as a rubber string. The bundle is carried by an operator, and is loaded on a conveying table in the bundle input portion L10. In the bundle input portion L10, five bundles B can be loaded, for example.

The bundle B loaded on the bundle input portion L10 is conveyed along a conveying route CL1 (X direction). The bundle input portion L10 transfers one of the bundles B which have been conveyed to the conveying destination position of the conveying route CL1 to a large belt cut stage ST of the large belt removing portion L20 along a conveying route CL2 (Y direction). In accordance with that one of the bundles B is transferred, the large belt removing portion L20 automatically cuts off the large belts Bw from the bundle B (step S102). The large belt removing portion L20 discards the cut large belt Bw (step S104).

Regarding the bundle B from which the large belt Bw has been removed, the sheaves SB are automatically conveyed along a conveying route CL3 by the sheaf combining portion L30 for each prescribed number of the sheaves SB. The sheaf combining portion L30 conveys a prescribed number of the sheaves SB for each plurality of the bundles B, and thereby combines a prescribed number of the sheaves contained in a plurality of the bundles B (step S106). The sheaf SB is manually inputted to the sheaf combining portion L30 for the conveying route CL3 by an operator P2. In accordance with that the sheaf SB is manually inputted, the sheaf combining portion L30 conveys the manually inputted sheaf SB along the conveying route CL3, and makes it to be combined with other sheaf SB (step S108).

The sheaf extracting portion L40 automatically extracts one sheaf SB from a plurality of sheaves SB combined by the sheaf combining portion L30 (step S110). The sheaf extracting portion L40 lifts one sheaf SB in the upward direction (Z direction), and thereby extracts one sheaf SB. The sheaf extracting portion L40 transfers the one extracted sheaf SB to the small belt removing portion L50 along the conveying route CL4.

The small belt removing portion L50 automatically cuts off the small belt SBw from the one sheaf SB transferred by the sheaf extracting portion L40 (step S112). The sheaf SB from which the small belt SBw has been cut off is released from the sealing, to become an unbound sheaf D. The small belt removing portion L50 conveys the one unbound sheaf D along a conveying route CL5, and transfers the one unbound sheaf D to the sheaf stacking portion L60 (step S122).

In addition, the small belt removing portion L50 images the bar code SBb of the small belt SBw removed from the sheaf SB (step S114). After having imaged the bar code SBb on which the sheaf information SBb has been printed, the small belt removing portion 150 discards the bar code SBb (step S116). The small belt removing portion L50 analyzes the image obtained by imaging the bar code SBb, and decodes the sheaf information. The small belt removing portion L50 updates the decoded sheaf information (step S118).

In accordance with that the one unbound sheaf D has been transferred, the sheaf stacking portion L60 inserts a secondary batch card BC-2 in the unbound sheaf D (step S124). In the secondary batch card BC-2, information to identify each unbound sheaf D is recorded. The sheet preprocessing apparatus L5 transmits the bar code information printed on the secondary batch card BC-2 to a banknote processing system (not shown) along with the sheaf information (step S120). The sheaf stacking portion L60 makes the secondary batch card BC-2 and the unbound sheaf D drop, and stacks them in the thickness direction of the sheet P (step S126). Each time the unbound sheaf D is transferred from the small belt removing portion L50, the sheaf stacking portion L60 repeats the insertion of the secondary batch card BC-2 and stacking of the unbound sheaf D. In addition, the sheaf stacking portion L60 may insert the secondary batch card BC-2 for each plurality of the unbound sheaves D. For example, the sheaf stacking portion L60 may insert the secondary batch card BC-2 for each prescribed number of the unbound sheaves D contained in the bundle B. After having stacked the unbound sheaves D of a plurality of the sheaves SB, the sheaf stacking portion L60 makes the stacked unbound sheaves D to be slid in a transfer direction L6, and transfers them to the main body processing apparatus L100 of the sheet P (step S128).

1. A sheet processing system, comprising:
a plurality of sheet processing apparatuses each of which has a plurality of stackers for stacking sheets, sorts and stacks the sheets in the plurality of stackers, and outputs information of a stacking status of the sheets in each of the plurality of stackers;
a sorting apparatus which sorts and feeds a sheet group formed of a plurality of the sheets to any of the plurality of sheet processing apparatuses;
a storage unit which stores the information of the stacking status of the sheets in each of the plurality of sheet processing apparatuses;
an information acquisition unit which acquires information of the sheet group; and
a controller which controls sorting of the sheet group by the sorting apparatus, based on the information of the sheet group acquired by the information acquisition unit and the information of the stacking status of the sheets stored in the storage unit.

2. The sheet processing system according to claim 1, wherein:
when sorting and stacking the sheets into the plurality of stackers, each of the plurality of sheet processing apparatuses dynamically changes correlation between each of at least a part of the plurality of stackers, and information of the sheets to be stacked in each of at least a part of the plurality of stackers.

3. The sheet processing system according to claim 1 or claim 2, wherein:
the controller determines whether or not the sheet processing apparatus exists which can stack the sheet group in any of the plurality of stackers, based on the information of the sheet group and the information of the stacking status of the sheets; and
when the sheet processing apparatus which can stack the sheet group does not exist, the sorting apparatus makes the sorting of the sheet group stand by, till it is determined by the controller that the sheet processing apparatus which can stack the sheet group exists.

4. The sheet processing system according to any one of claim 1 to claim 3, wherein:
the information acquisition unit executes at least one of acquisition of information which has been previously given to the sheet group, and detection of the state of the sheet group.
